(19) United States
(12) Patent Application Publication
(10) Pub. No.: US 2021/0408636 A1
(43) Pub. Date: Dec. 30, 2021

(54) NONAQUEOUS ELECTROLYTE SECONDARY BATTERY LAMINATED SEPARATOR

(71) Applicant: Sumitomo Chemical Company, Limited, Tokyo (JP)

(72) Inventors: Kensaku HORIE, Niihama City (JP); Hiroki HASHIWAKI, Niihama City (JP); Eri HAYASHI, Niihama City (JP)

(21) Appl. No.: 17/362,227

(22) Filed: Jun. 29, 2021

(30) Foreign Application Priority Data
Jun. 30, 2020 (JP) 2020-113259
Jun. 23, 2021 (JP) 2021-104360

(51) Int. Cl. H01M 50/417; H01M 4/62; H01M 4/525; H01M 4/505

(52) U.S. Cl. CPC H01M 50/417; H01M 4/622; H01M 2004/027; H01M 4/505; H01M 4/626; H01M 4/525

(57) ABSTRACT

A nonaqueous electrolyte secondary battery laminated separator which is not altered in properties even after long-time charging under a high voltage condition and excels in heat resistance is described. The nonaqueous electrolyte secondary battery laminated separator includes a polyolefin porous film and a porous layer, the porous layer contains a binder resin and a filler, and an area of an opening in the nonaqueous electrolyte secondary battery laminated separator is 7.0 mm² or less when the nonaqueous electrolyte secondary battery laminated separator is subjected to a certain heat resistance test.

This Nonprovisional application claims priority under 35 U.S.C. § 119 on Patent Application No. 2020-113259 filed in Japan on Jun. 30, 2020 and Patent Application No. 2021-104360 filed in Japan on Jun. 23, 2021, the entire contents of which are hereby incorporated by reference.

### TECHNICAL FIELD

The present invention relates to a laminated separator for a nonaqueous electrolyte secondary battery (hereinafter referred to as a “nonaqueous electrolyte secondary battery laminated separator”).

### BACKGROUND ART

Nonaqueous electrolyte secondary batteries, particularly lithium ion secondary batteries, have a high energy density and are therefore in wide use as batteries for personal computers, mobile phones, portable information terminals, and the like. Such nonaqueous electrolyte secondary batteries are recently being developed as on-vehicle batteries.

It is demanded that a nonaqueous electrolyte secondary battery can be charged under a high voltage condition. For this reason, a nonaqueous electrolyte secondary battery laminated separator should be excellent in heat resistance and in deterioration resistance without being altered in properties even after the charging is carried out.

Patent Literature 1 discloses (i) a wholly aromatic polyamide in which an aromatic ring at a polymer chain end has no amino group and the aromatic ring has an electron-withdrawing substituent group, and (ii) a feature in which, even if a high voltage is applied, the wholly aromatic polyamide has less discoloration.

### CITATION LIST

### Patent Literature

[Patent Literature 1]
Japanese Patent Application Publication Tokukai No. 2003-40999 (Publication date: Feb. 13, 2003)

### SUMMARY OF INVENTION

### Technical Problem

Patent Literature 1 discloses the following results: when constant-current and constant-voltage charging is carried out under a condition in which a state of 4.5 V is maintained for one day, discoloration of a laminated separator used as a member of a flat plate battery is hardly seen.

However, for example, when trickle charging is carried out, in many cases, the charging is carried out at a high voltage for a considerably longer period than one day. Patent Literature 1 does not indicated, however, that the laminated separator is not altered in properties and is excellent in heat resistance and deterioration resistance even in such cases.

Under the circumstances, an objective of an aspect of the present invention is to provide a nonaqueous electrolyte secondary battery laminated separator which is not altered in properties even after long-time charging under a high voltage condition and excels in heat resistance and in deterioration resistance.

### Solution to Problem

The present invention has aspects described in [1] through [12] below.

[1] A nonaqueous electrolyte secondary battery laminated separator including a polyolefin porous film and a porous layer, the porous layer containing a binder resin and a filler, and an area of an opening in the nonaqueous electrolyte secondary battery laminated separator being 7.0 mm² or less when the nonaqueous electrolyte secondary battery laminated separator is subjected to the following heat resistance test:

Step 1) a test battery is prepared by impregnating a laminated body with a nonaqueous electrolyte, the laminated body including a positive electrode, the nonaqueous electrolyte secondary battery laminated separator, and a negative electrode which are stacked in this order such that a positive electrode active material layer included in the positive electrode makes contact with the porous layer, the positive electrode containing a positive electrode active material that is capable of being doped with and dedoped of lithium ions, and the negative electrode containing a negative electrode active material that is capable of being doped with and dedoped of lithium ions;

Step 2) the test battery is subjected to constant-current charging with an electric current of 1 C at 25° C. up to 4.6 V (vs Li/Li⁺), and is then subjected to trickle charging with 4.6 V (vs Li/Li⁺) at 25° C. for 168 hours;

Step 3) the nonaqueous electrolyte secondary battery laminated separator is taken out from the test battery after Step 2;

Step 4) the nonaqueous electrolyte secondary battery laminated separator is pierced with a metal stick having a temperature of 450° C. and a diameter of 2.2 mm from a side on which the porous layer was in contact with the positive electrode active material layer,

wherein the positive electrode is a positive electrode in which lithium nickel cobalt manganese oxide (LiNi_{0.5}Co_{0.2}Mn_{0.3}O₂) is formed on an aluminum foil,

the negative electrode is a negative electrode in which natural graphite is formed on a copper foil, and

the nonaqueous electrolyte has been prepared by dissolving LiPF₆ in a mixed solvent of ethylene carbonate, ethyl methyl carbonate, and diethyl carbonate at a ratio of 3:5:2 (volume ratio) so that the LiPF₆ is contained at 1 mol/L.

[2] The nonaqueous electrolyte secondary battery laminated separator described in [1], in which a content of the filler in the porous layer is not less than 40% by weight and not more than 70% by weight, where a weight of the porous layer is 100% by weight.

[3] The nonaqueous electrolyte secondary battery laminated separator described in [1] or [2], in which: the filler is a metal oxide filler; and the binder resin includes one or more resins selected from the group consisting of a (meth)acrylate-based resin, a fluorine-containing resin, a polyamide-based resin, a polyimide-based resin, a polyamide imide-based resin, a polyester-based resin, and a water-soluble polymer.

[4] The nonaqueous electrolyte secondary battery laminated separator described in any of [1] through [3], in which the porous layer contains an aramid resin.

[5] The nonaqueous electrolyte secondary battery laminated separator described in [4], in which the aramid resin contained in the porous layer satisfies a relation of (X2/X1)×100≥80(%),

where X1 is (a) maximum peak intensity in a range of 1490 cm⁻¹ to 1530 cm⁻¹ of a surface of the porous layer, the maximum peak intensity being of IR intensity measured in the surface of the porous layer by an ATR-IR method before starting the trickle charging in Step 2; or (b) maximum peak intensity in a range of 1490 cm⁻¹ to 1530 cm⁻¹ of a non-contact part of the surface of the porous layer, the maximum peak intensity being of IR intensity measured in the non-contact part by the ATR-IR method after the trickle charging in Step 2, and the non-contact part having not been in contact with the positive electrode active material layer included in the positive electrode during the trickle charging, and

X2 is maximum peak intensity of a contact part of the surface of the porous layer in a range of 1490 cm⁻¹ to 1530 cm⁻¹, the maximum peak intensity being of IR intensity measured in the contact part by the ATR-IR method after the trickle charging in Step 2, and the contact part having been in contact with the positive electrode active material layer included in the positive electrode during the trickle charging.

[6] The nonaqueous electrolyte secondary battery laminated separator described in [4] or [5], in which: in the aramid resin, (i) each of aromatic rings in a main chain has an electron-withdrawing group, (ii) at least one end of a molecule is an amino group, and (iii) more than 90% of bonds with which the aromatic rings in the main chain are connected to each other are amide bonds.

[7] The nonaqueous electrolyte secondary battery laminated separator described in [6], in which the aramid resin has no ether bond as the bonds with which the aromatic rings in the main chain are connected to each other.

[8] The nonaqueous electrolyte secondary battery laminated separator described in [6] or [7], in which: in the aramid resin, (iv) 40% or more of aromatic diamine-derived units have electron-withdrawing groups, and (v) 20% or less of acid chloride-derived units have electron-withdrawing groups.

[9] The nonaqueous electrolyte secondary battery laminated separator described in any of [6] through [8], in which the electron-withdrawing group is one or more groups selected from the group consisting of halogen, a cyano group, and a nitro group.

[10] The nonaqueous electrolyte secondary battery laminated separator described in any of [4] through [8], in which the aramid resin has an intrinsic viscosity of 1.4 dL/g to 4.0 dL/g.

[11] A nonaqueous electrolyte secondary battery member, including a positive electrode, a nonaqueous electrolyte secondary battery laminated separator described in any of [1] through [10], and a negative electrode which are stacked in this order.

[12] A nonaqueous electrolyte secondary battery, including: a nonaqueous electrolyte secondary battery laminated separator described in any of [1] through [10]; or a nonaqueous electrolyte secondary battery member described in [11].

### Advantageous Effects of Invention

According to an aspect of the present invention, it is possible to provide a nonaqueous electrolyte secondary battery laminated separator which is not altered in properties even after long-time charging under a high voltage condition, and excels in heat resistance and in deterioration resistance.

### BRIEF DESCRIPTION OF DRAWINGS

FIG. 1 is a diagram illustrating an example of procedures in Step 4 of a heat resistance test in Embodiment 1 of the present invention.

FIG. 2 is a diagram for explaining a method for interpreting results of the heat resistance test in Embodiment 1 of the present invention.

### DESCRIPTION OF EMBODIMENTS

The following description will discuss embodiments of the present invention. The present invention is, however, not limited to the embodiments below. The present invention is not limited to arrangements described below, but may be altered in various ways by a skilled person within the scope of the claims. The present invention also encompasses, in its technical scope, any embodiment derived by appropriately combining technical means disclosed in differing embodiments. Note that a numerical range “A to B” herein means “A or more (higher) and B or less (lower)” unless otherwise stated.

### Embodiment 1: Nonaqueous Electrolyte Secondary Battery Laminated Separator

The nonaqueous electrolyte secondary battery laminated separator in accordance with an embodiment of the present invention includes a polyolefin porous film (hereinafter sometimes simply referred to as “porous film”) and a porous layer,

the porous layer containing a binder resin and a filler, and

an area of an opening in the nonaqueous electrolyte secondary battery laminated separator being 7.0 mm² or less when the nonaqueous electrolyte secondary battery laminated separator is subjected to the following heat resistance test:

Step 1) a test battery is prepared by impregnating a laminated body with a nonaqueous electrolyte, the laminated body including a positive electrode, the nonaqueous electrolyte secondary battery laminated separator, and a negative electrode which are stacked in this order such that a positive electrode active material layer included in the positive electrode makes contact with the porous layer, the positive electrode containing a positive electrode active material that is capable of being doped with and dedoped of lithium ions, and the negative electrode containing a negative electrode active material that is capable of being doped with and dedoped of lithium ions;

Step 2) the test battery is subjected to constant-current charging with an electric current of 1 C at 25° C. up to 4.6 V (vs Li/Li⁺), and is then subjected to trickle charging with 4.6 V (vs Li/Li⁺) at 25° C. for 168 hours;

Step 3) the nonaqueous electrolyte secondary battery laminated separator is taken out from the test battery after Step 2;

Step 4) the nonaqueous electrolyte secondary battery laminated separator is pierced with a metal stick having a temperature of 450° C. and a diameter of 2.2 mm from a side on which the porous layer was in contact with the positive electrode active material layer,

wherein the positive electrode is a positive electrode in which lithium nickel cobalt manganese oxide (LiNi_{0.5}Co_{0.2}Mn_{0.3}O₂) is formed on an aluminum foil,

the negative electrode is a negative electrode in which natural graphite is formed on a copper foil, and

the nonaqueous electrolyte has been prepared by dissolving LiPF₆ in a mixed solvent of ethylene carbonate, ethyl methyl carbonate, and diethyl carbonate at a ratio of 3:5:2 (volume ratio) so that the LiPF₆ is contained at 1 mol/L.

(1. Heat Resistance Test)

According to the nonaqueous electrolyte secondary battery laminated separator in accordance with an embodiment of the present invention, an area of an opening in the nonaqueous electrolyte secondary battery laminated separator is 7.0 mm² or less when the nonaqueous electrolyte secondary battery laminated separator is subjected to the heat resistance test. The nonaqueous electrolyte secondary battery laminated separator satisfies the feature, and therefore is not altered in properties even after long-time charging under a high voltage condition, and excels in heat resistance and in deterioration resistance, as shown in Examples described later.

(1-1. Step 1)

The positive electrode included in the test battery that is used in Step 1 contains a positive electrode active material which is capable of being doped with and dedoped of lithium ions. The positive electrode active material is lithium nickel cobalt manganese oxide (LiNi_{0.5}Co_{0.2}Mn_{0.3}O₂). The lithium nickel cobalt manganese oxide is preferable because of having a higher average discharge potential.

The positive electrode active material is preferably formed on a current collector together with, for example, a binding agent, a conductive auxiliary agent, and the like, and is formed as a positive electrode active material layer. The current collector is an aluminum foil.

Examples of a method for producing the positive electrode include: a method in which the positive electrode active material, the conductive auxiliary agent, and the binding agent are pressure-molded on the positive electrode current collector; and a method in which (i) the positive electrode active material, the conductive auxiliary agent, and the binding agent are formed into a paste with use of an appropriate organic solvent, (ii) the positive electrode current collector is coated with the paste, and (iii) the paste is dried and then pressured so that the paste is firmly fixed to the positive electrode current collector.

The negative electrode included in the test battery that is used in Step 1 contains a negative electrode active material which is capable of being doped with and dedoped of lithium ions. The negative electrode active material is natural graphite.

The negative electrode active material is preferably formed on a current collector together with, for example, a binding agent, a conductive auxiliary agent, and the like, and is formed as a negative electrode active material layer. The current collector is a copper foil.

The natural graphite is preferably used for the following reasons: during charging, an electric potential of the negative electrode hardly changes (i.e., potential evenness is good) from an uncharged state to a fully charged state; the average discharge potential is low; a capacity maintenance ratio is high when being repeatedly charged and discharged (i.e., cycle characteristic is good); and the like.

Examples of a method for producing the negative electrode include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressured so that the paste is firmly fixed to the negative electrode current collector. The above paste preferably includes the conductive auxiliary agent and the binding agent.

In Step 1, a laminated body is obtained by stacking the positive electrode, the nonaqueous electrolyte secondary battery laminated separator, and the negative electrode in this order such that the positive electrode active material layer included in the positive electrode makes contact with the porous layer. The wording “the positive electrode active material layer . . . makes contact with the porous layer” means that a surface of the positive electrode active material layer of the positive electrode and a surface of the porous layer, which face each other, at least partially overlap each other.

When the test battery is subjected to trickle charging, a high voltage is to be applied, for a long time, to a contact part which is of the porous layer and makes contact with the positive electrode active material layer. Therefore, in the contact part, it is easy to determine deterioration caused due to a high voltage on the nonaqueous electrolyte secondary battery laminated separator. This is the reason why the porous layer and the positive electrode active material layer are stacked to come into contact with each other.

In this case, the surface of the positive electrode active material layer and the surface of the porous layer which face each other are preferably arranged as follows: that is, the whole surface of the positive electrode active material layer makes contact with the surface of the porous layer. In addition, it is preferable that the surface of the porous layer has a surface area larger than that of the positive electrode active material layer and that a part of the surface of the porous layer is not in contact with the surface of the positive electrode active material layer. The part which is of the surface of the porous layer and does not overlap the surface of the positive electrode active material layer can be in contact with a surface of the current collector.

The part which is of the surface of the porous layer and is not in contact with the surface of the positive electrode active material layer will not be altered in properties even when being subjected to trickle charging. Therefore, it can be said that this part is in the same state as the porous layer prior to starting of trickle charging. Therefore, this part can be regarded as the surface of the porous layer prior to starting of trickle charging.

The test battery can be prepared by impregnating the laminated body with a nonaqueous electrolyte. A method of impregnation is not particularly limited. For example, a method can be employed which includes the steps of: inserting the laminated body into a container that serves as a housing of the test battery; then filling the container with a nonaqueous electrolyte; and then hermetically sealing the container under reduced pressure.

The nonaqueous electrolyte is prepared by dissolving LiPF₆ in a mixed solvent of ethylene carbonate, ethyl methyl carbonate, and diethyl carbonate at a ratio of 3:5:2 (volume ratio) so that the LiPF₆ is contained at 1 mol/L. This nonaqueous electrolyte is preferable because of having a wide range of operating temperatures, being hardly deteriorated even when being charged and discharged at a high current rate, and being hardly deteriorated even when being used for a long period of time.

(1-2. Step 2)

In Step 2, the test battery obtained in Step 1 is subjected to constant-current charging with an electric current of 1 C at 25° C. up to 4.6 V (vs Li/Li⁺), and is then subjected to trickle charging with 4.6 V (vs Li/Li⁺) at 25° C. for 168 hours.

By the trickle charging under the above condition, the porous layer is applied with a high voltage for a long time. In this case, if the porous layer has low heat resistance, the porous layer exhibits property alteration such as discoloration, and a large crack occurs in Step 4 described later. Therefore, it can be said that Step 2 deliberately promotes deterioration of the porous layer in order to determine heat resistance of the porous layer.

(1-3. Step 3)

In Step 3, the nonaqueous electrolyte secondary battery laminated separator is taken out from the test battery after Step 2. A method of taking out the nonaqueous electrolyte secondary battery laminated separator is not particularly limited, and the test battery can be disassembled according to a conventional method to take out the nonaqueous electrolyte secondary battery laminated separator.

(1-4. Step 4)

In Step 4, the nonaqueous electrolyte secondary battery laminated separator which has been taken out from the test battery is pierced with a metal stick having a temperature of 450° C. and a diameter of 2.2 mm from a side on which the porous layer was in contact with the positive electrode active material layer. As described above, a high voltage is applied to the part which is of the porous layer and is in contact with the positive electrode active material layer for a long time. Therefore, if the porous layer is formed on both sides of the polyolefin porous film, the metal stick pierces the separator from the side on which the porous layer was in contact with the positive electrode active material layer.

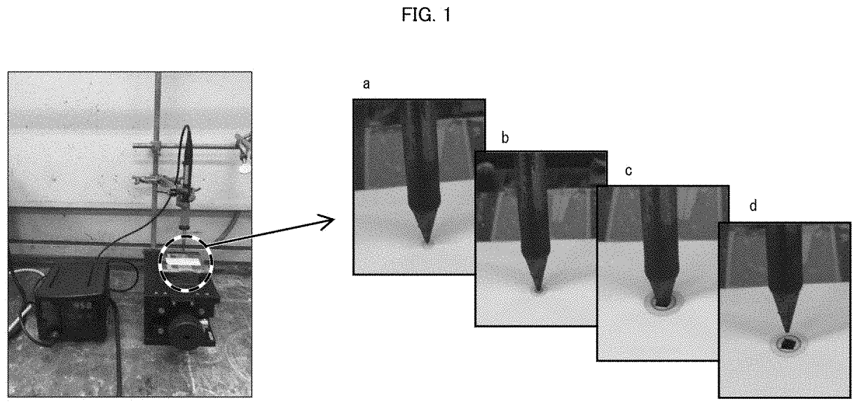

FIG. 1 is a diagram illustrating an example of procedures in Step 4. The left part of FIG. 1 shows an appearance of a solder test apparatus used to carry out Step 4. As the solder test apparatus, for example, it is possible to use RX-802AS available from TAIYO ELECTRIC IND. CO., LTD. Moreover, “a” through “d” in FIG. 1 show that Step 4 proceeds from “a” to “d”.

The nonaqueous electrolyte secondary battery laminated separator is placed on a table indicated by a dotted-line frame in the left part of FIG. 1 such that the porous layer side faces upward. Next, the metal stick, which has the temperature of 450° C., has the diameter of 2.2 mm, and is disposed above the table, is brought close to the porous layer, and a tip of the metal stick is brought into contact with the surface of the porous layer as shown in “a” in FIG. 1.

In this case, the tip of the metal stick is maintained at a position at which the tip is in contact with the surface of the porous layer without applying a downward load. As the metal stick, for example, a soldering iron can be used as shown in FIG. 1. The temperature of 450° C. is a temperature of the entire metal stick, and the diameter of 2.2 mm is a diameter of the tip of the metal stick.

In FIG. 1, “a” shows a state immediately after the tip is brought into contact with the surface of the porous layer. By maintaining the tip at the position, heat from the metal stick is propagated to the nonaqueous electrolyte secondary battery laminated separator. As a result, as shown in “a” in FIG. 1, a substantially concentric circular region (hereinafter referred to as “region 1”) is formed around the tip. The region 1 is an area generated when the polyolefin (polyethylene) constituting the polyolefin porous film is melted.

In FIG. 1, “b” shows a state in which a time has elapsed from “a” in FIG. 1. In accordance with thermal hysteresis, the region 1 is larger than that in “a” in FIG. 1, and a new circular region is formed outside the tip.

In FIG. 1, “c” shows a state in which a time has elapsed from “b” in FIG. 1. A black opening is formed around the tip, and the tip is piercing the nonaqueous electrolyte secondary battery laminated separator. On the outer side of the opening, a clear circular region (hereinafter referred to as “region 2”) is formed so as to directly surround the opening. The region 2 is an area generated when the polyolefin (polyethylene) constituting the polyolefin porous film is melted inside the binder resin contained in the porous layer. On the further outer side, a region is present in which the polyolefin shown in “a” in FIG. 1 is melted.

In FIG. 1, “d” shows a state immediately after the metal stick is brought away from the nonaqueous electrolyte secondary battery laminated separator and Step 4 is thus completed. A duration from “a” to “d” in FIG. 1 is 10 seconds. In “d”, projection patterns are seen from the opening toward the circle surrounding the opening. The projection patterns are cracks that occurred in the nonaqueous electrolyte secondary battery laminated separator.

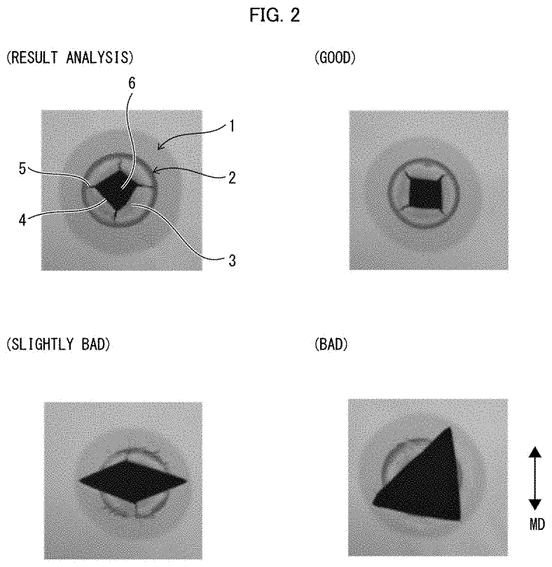

FIG. 2 is a diagram for explaining a method for interpreting results of the heat resistance test. In FIG. 2, “1” in “RESULT ANALYSIS” indicates the region 1, which is a semitransparent region in which the polyethylene constituting the base material is melted. “2” indicates the region 2, which is a transparent region generated when the polyethylene is melted inside the binder resin contained in the porous layer. “3” indicates a brownish white region which seems to have been generated by deterioration of the polyethylene by oxidation. “4” indicates a region in which the porous layer is curled. “5” indicates a crack, and “6” indicates an opening. “MD” is an abbreviation for machine direction.

If all cracks do not go beyond the region 2, such a state can be determined as a good result, as shown in “(GOOD)” in FIG. 2. If some cracks go beyond the region 2 and the other cracks do not go beyond the region 2, such a state can be determined as a slightly bad result. If all cracks go beyond the region 2 and reach the region 1, such a state can be determined as a bad result.

According to the nonaqueous electrolyte secondary battery laminated separator in accordance with an embodiment of the present invention, an area of an opening in the nonaqueous electrolyte secondary battery laminated separator is 7.0 mm² or less when the nonaqueous electrolyte secondary battery laminated separator is subjected to the above heat resistance test. That is, the area of the opening measured after Step 4 is 7.0 mm² or less.

The feature in which “the area of the opening is 7.0 mm² or less” corresponds to the result shown as “(Good)” in FIG. 2. With the feature, it can be said that property alteration in the nonaqueous electrolyte secondary battery laminated separator is sufficiently inhibited. Therefore, in this case, the nonaqueous electrolyte secondary battery laminated separator can be said to excel in heat resistance and deterioration resistance under a high voltage condition.

The area of the opening is more preferably 7.0 mm² or less, and particularly preferably 5.0 mm² or less, from the viewpoint of providing a nonaqueous electrolyte secondary battery laminated separator having more excellent heat resistance. The area is preferably as small as possible but, in practice, a lower limit is approximately 1.0 mm². The area can be measured by an image analysis method using an optical microscope.

The area of the opening can be controlled to be 7.0 mm² or less by, for example, coating the polyolefin porous film with an aramid resin having heat resistance.

(2. Porous Layer)

The porous layer is formed on at least one surface of the porous film to constitute the nonaqueous electrolyte secondary battery laminated separator in accordance with an embodiment of the present invention. The porous layer is preferably an insulating porous layer.

The porous layer has a structure in which many pores, connected to one another, are provided, so that the porous layer is a layer through which a gas or a liquid can pass from one surface to the other. The porous layer contains a binder resin and a filler.

The filler is preferably a heat-resistant filler. The heat-resistant filler can be an inorganic filler or an organic filler, and preferably contains an inorganic filler. The heat-resistant filler means a filler having a melting point of not lower than 150° C.

From the viewpoint of improving heat resistance of the porous layer, a content of the filler in the porous layer is preferably not less than 40% by weight and not more than 70% by weight, where a weight of the porous layer is 100% by weight. The content is more preferably not less than 50% by weight and less than 70% by weight.

As the filler, it is possible to employ, for example, one or more inorganic fillers selected from inorganic substances such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass.

Among those, the filler is preferably a metal oxide filler, from the viewpoint of improving heat resistance of the porous layer. The term “metal oxide filler” indicates an inorganic filler composed of metal oxide. The metal oxide filler can be, for example, an inorganic filler made of an aluminum oxide and/or a magnesium oxide.

Examples of organic substances constituting the organic filler include one or more selected from (i) a homopolymer of a monomer such as styrene, vinyl ketone, acrylonitrile, methyl methacrylate, ethyl methacrylate, glycidyl methacrylate, glycidyl acrylate, or methyl acrylate, or (ii) a copolymer of two or more of such monomers; fluorine-containing resins such as polytetrafluoroethylene, an ethylene tetrafluoride/propylene hexafluoride copolymer, an ethylene tetrafluoride/ethylene copolymer, and polyvinylidene fluoride; a melamine resin; a urea resin; polyethylene; polypropylene; polyacrylic acid and polymethacrylic acid; a resorcinol resin; and the like.

An average particle diameter (D50) of the filler is preferably 0.001 μm or more and 10 μm or less, more preferably 0.01 μm or more and 8 μm or less, further preferably 0.05 μm or more and 5 μm or less. The average particle diameter of the filler is a value measured with use of MICROTRAC (MODEL: MT-3300EXII) available from NIKKISO CO., LTD.

A shape of the filler varies depending on a method for producing a raw material, i.e., an organic substance or an inorganic substance, a dispersion condition of the filler in preparing a coating liquid for forming the porous layer, and the like. Accordingly, the shape of the filler can be any of various shapes including (i) a shape such as a spherical shape, an oval shape, a rectangular shape, a gourd-like shape and (ii) an indefinite shape having no specific shape.

It is preferable that the binder resin is insoluble in the electrolyte of the battery and is electrochemically stable when the battery is in normal use. In view of this, the binder resin preferably includes one or more resins selected from the group consisting of a (meth)acrylate-based resin, a fluorine-containing resin, a polyamide-based resin, a polyimide-based resin, a polyamide imide-based resin, a polyester-based resin, and a water-soluble polymer.

It is preferable that the porous layer contains an aramid resin. That is, it is preferable that the polyamide-based resin is an aramid resin, from the viewpoint of improving safety at the time of short circuit inside the battery, and the like.

The aramid resin includes aromatic polyamide, wholly aromatic polyamide, and the like. The aromatic polyamide is preferably one or more resins selected from the group consisting of para(p)-aromatic polyamide and meth(m)-aromatic polyamide.

Specific examples of the aramid resins include one or more selected from poly(paraphenylene terephthalamide), poly(metaphenylene isophthalamide), poly(metaphenylene terephthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/metaphenylene terephthalamide copolymer, a paraphenylene terephthalamide/2,6-dichloroparaphenylene terephthalamide copolymer, and a metaphenylene terephthalamide/2,6-dichloroparaphenylene terephthalamide copolymer.

Among these, poly(paraphenylene terephthalamide), poly(metaphenylene terephthalamide), and the paraphenylene terephthalamide/metaphenylene terephthalamide copolymer are preferable.

The aramid resin contained in the porous layer preferably satisfies a relation of (X2/X1)×100≥80(%),

where X1 is (a) maximum peak intensity in a range of 1490 cm⁻¹ to 1530 cm⁻¹ of a surface of the porous layer, the maximum peak intensity being of IR intensity measured in the surface of the porous layer by an ATR-IR method before starting the trickle charging in Step 2; or (b) maximum peak intensity in a range of 1490 cm⁻¹ to 1530 cm⁻¹ of a non-contact part of the surface of the porous layer, the maximum peak intensity being of IR intensity measured in the non-contact part by the ATR-IR method after the trickle charging in Step 2, and the non-contact part having not been in contact with the positive electrode active material layer included in the positive electrode during the trickle charging, and

X2 is maximum peak intensity of a contact part of the surface of the porous layer in a range of 1490 cm⁻¹ to 1530 cm⁻¹, the maximum peak intensity being of IR intensity measured in the contact part by the ATR-IR method after the trickle charging in Step 2, and the contact part having been in contact with the positive electrode active material layer included in the positive electrode during the trickle charging.

A peak derived from an amide group appears in the range of 1490 cm⁻¹ to 1530 cm⁻¹. A fact that the aramid resin satisfies the above relation means that a residual ratio of the amide group of the aramid resin contained in the porous layer is high even after undergoing a trickle test. That is, even after a high voltage is applied for a long time, a structure retention ratio of the aramid resin is high. Therefore, the nonaqueous electrolyte secondary battery laminated separator in accordance with an embodiment of the present invention which satisfies the above relation can be said to have high heat resistance and high deterioration resistance.

As described in (1-1. Step 1) above, the part which is of the surface of the porous layer and is not in contact with the surface of the positive electrode active material layer will not be altered in properties even when being subjected to trickle charging. Therefore, this part can be regarded as the surface of the porous layer prior to starting of trickle charging. From this, the maximum peak intensity X1 of (a) and maximum peak intensity X1 of (b) are substantially the same, and therefore X1 can be either (a) or (b).

The surface of the porous layer which has been in contact with the positive electrode active material layer during trickle charging has deliberately undergone the step of prompting deterioration of the porous layer as described in (1-2. Step 2) above. Therefore, when the aramid resin satisfies the relation of (X2/X1)×100≥80(%), the nonaqueous electrolyte secondary battery laminated separator in accordance with an embodiment of the present invention can be said to exhibit good resistance to deterioration, even though the nonaqueous electrolyte secondary battery laminated separator has undergone such a step.

The maximum peak strength can be determined by subjecting the nonaqueous electrolyte secondary battery laminated separator to an apparatus capable of carrying out the ATR-IR method and measuring IR intensity on the surface of the porous layer. As the apparatus, for example, Cary600 FTIR available from Agilent can be used.

As a method of controlling the aramid resin to satisfy the above relation, it is possible to employ a method of controlling a molecular structure of the aramid resin so that the aramid resin satisfies the following (i) through (iii).

According to the nonaqueous electrolyte secondary battery laminated separator in accordance with an embodiment of the present invention, it is preferable, in the aramid resin, that (i) each of aromatic rings in a main chain has an electron-withdrawing group, (ii) at least one end of a molecule is an amino group, and (iii) more than 90% of bonds with which the aromatic rings in the main chain are connected to each other are amide bonds.

When the binder resin contained in the porous layer is an aramid resin and the binder resin is used in a high voltage environment, it tends to be difficult to maintain heat resistance (e.g., discoloration tends to appear), as compared with other binder resins described above. However, the inventors of the present invention have found that, by satisfying the above conditions (i) through (iii), oxidation resistance of the aramid resin can be improved and, as a result, it is possible to greatly improve the heat resistance of the nonaqueous electrolyte secondary battery laminated separator using the aramid resin.

A main chain of the aramid resin has, for example, a structure indicated in parentheses of a chemical formula below. Note that, in the chemical formula below, bonds with which aromatic rings included in the main chain are connected to each other are only amide bonds. However, the embodiment of the present invention is not necessarily limited to this, provided that more that 90% of the bonds are amide bonds. Such other bonds can be an ether bond, a sulfonyl bond, and the like.

A proportion of the amide bonds occupying the bonds is more preferably 95% or more, and most preferably 100%. The aramid resin preferably has no ether bond as the bonds with which the aromatic rings in the main chain are connected to each other.

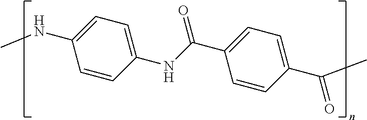

Examples of the electron-withdrawing group include halogen, —CN, —NO₂, —⁺NH₃, —CF₃, —CCl₃, —CHO, —COCH₃, —CO₂C₂H₅, —CO₂H, —SO₂CH₃, —SO₃H, —OCH₃, and the like. The electron-withdrawing group can be one type or can be two or more types.

Among those, from the viewpoint of prices, the electron-withdrawing group is preferably one or more groups selected from the group consisting of halogen, a cyano group, and a nitro group, which are generally distributed.

Both ends or at least one end of the molecule of the aramid resin is an amino group. That is, at least one of aromatic rings at ends of the molecule has an amino group.

The aramid resin satisfying the above conditions (i) through (iii) can be produced by causing an aromatic diamine to react with an acid chloride in a solvent.

It is preferable, in the aramid resin, that (iv) 40% or more of aromatic diamine-derived units have electron-withdrawing groups, and (v) 20% or less of acid chloride-derived units have electron-withdrawing groups.

The term “aromatic diamine-derived unit” refers to a structural unit represented by —(NH—Ar—NH)—. This structural unit also includes NH₂—Ar—NH— and —NH—Ar—NH₂, which are structural units in which an end thereof is an amino group. The feature “40% or more of the units have electron-withdrawing groups” means that 40% or more of aromatic rings (Ar) in the units present within the molecule of the aramid resin have electron-withdrawing groups.

A ratio at which the aromatic diamine-derived units have the electron-withdrawing groups is more preferably 50% or more, more preferably 75% or more, and most preferably 100%.

The term “acid chloride-derived unit” refers to a structural unit represented by —(CO—Ar—CO)—. The feature “20% or less of the units have electron-withdrawing groups” means that 20% or less of aromatic rings (Ar) in the units present within the molecule of the aramid resin have electron-withdrawing groups. A ratio at which the acid chloride-derived units have the electron-withdrawing groups is preferably as low as possible, more preferably 10% or less, and most preferably 0%.

The aramid resin preferably satisfies the above conditions (iv) and (v) because the area of the opening tends to become smaller when being subjected to the foregoing heat resistance test.

The aramid resin which satisfies the conditions (iv) and (v) in addition to the conditions (i) through (iii) can be produced by controlling, in aromatic diamines and acid chlorides used as raw materials, a proportion of aromatic diamines and acid chlorides which have electron-withdrawing groups.

From the viewpoint of improving heat resistance of the porous layer, in the nonaqueous electrolyte secondary battery laminated separator in accordance with an embodiment of the present invention, an intrinsic viscosity of the aramid resin is preferably 1.4 dL/g to 4.0 dL/g. The intrinsic viscosity can be confirmed, for example, by a method disclosed in WO2016/002785. That is, 0.5 g of an aramid resin is dissolved in 100 mL of concentrated sulfuric acid, and the intrinsic viscosity is measured using a capillary viscometer. As a method of controlling the intrinsic viscosity, it is possible to use a method of controlling a ratio of monomers used in polymerizing an aramid resin.

(3. Production of Nonaqueous Electrolyte Secondary Battery Laminated Separator)

The nonaqueous electrolyte secondary battery laminated separator in accordance with an embodiment of the present invention can be produced by a method including: a step of laminating one surface or both surfaces of the polyolefin porous film with a coating liquid containing the binder resin and the filler described above; and a step of removing a solvent in the coating liquid.

The coating liquid can be obtained by mixing the binder resin and the filler with the solvent. From the viewpoint of improving heat resistance of the porous layer, a content of the filler is preferably 40% by weight to 70% by weight, more preferably 50% by weight to 70% by weight, where a weight of the binder resin and the filler is 100% by weight.

Examples of the solvent include a nonpolar solvent disclosed in WO2016/002785. Specifically, the solvent can be N-methylpyrrolidone, N,N-dimethylacetamide, N,N-dimethylformamide, or the like. Each of these solvents can be used solely. Alternatively, two or more of these solvents can be used in combination.

The step of laminating the surface with the coating liquid can be carried out by laminating one surface or both surfaces of the porous film with the coating liquid by, for example, a gravure coater method, a dip coater method, a bar coater method, or a die coater method.

The step of removing the solvent in the coating liquid can be carried out by drying and removing the solvent. Thus, a porous layer is formed on one surface or both surfaces of the porous film (base material), and a nonaqueous electrolyte secondary battery laminated separator is obtained.

Removal of the solvent can also be carried out, for example, by the following method.

(1) Coating one surface or both surfaces of a base material with the composition, and then immersing the base material into a deposition solvent (which is a poor solvent for the binder resin) for deposition of the binder to form a porous layer, and then drying the porous layer to remove the solvent.

(2) Coating one surface or both surfaces of a base material with the composition, and then depositing the binder resin with use of a low-boiling-point solvent to form a porous layer, and then drying the porous layer to remove the solvent.

As the deposition solvent, for example, water, ethyl alcohol, isopropyl alcohol, acetone, or the like can be used.

The porous film contains polyolefin as a main component and has a large number of pores connected to one another, and allows a gas and a liquid to pass therethrough from one surface to the other. The porous film serves as a base material on which the porous layer is formed in the laminated body. The porous layer has a structure in which many pores, connected to one another, are provided, so that the porous layer is a layer through which a gas or a liquid can pass from one surface to the other.

The porous film contains a polyolefin at a proportion of not less than 50% by volume, preferably not less than 90% by volume, more preferably not less than 95% by volume, relative to the entire porous film.

The polyolefin more preferably contains a high molecular weight component having a weight-average molecular weight of 5×10⁵ to 15×10⁶. In particular, the polyolefin more preferably contains a high molecular weight component having a weight-average molecular weight of not less than 1,000,000 because such a polyolefin allows the laminated body to have higher strength.

Examples of the polyolefin include a homopolymer or a copolymer each produced by polymerizing monomers such as ethylene, propylene, 1-butene, 4-methyl-1-pentene, or 1-hexene. Examples of the homopolymer include polyethylene, polypropylene, and polybutene. Examples of the copolymer include an ethylene/propylene copolymer.

Among the above examples, polyethylene is more preferable as it is capable of preventing a flow of an excessively large electric current at a lower temperature.

Examples of the polyethylene include low-density polyethylene, high-density polyethylene, linear polyethylene (ethylene/α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is further preferable.

The porous film has a film thickness of preferably 4 μm to 40 μm, more preferably 5 μm to 30 μm, still more preferably 6 μm to 15 μm.

The porous film can have a weight per unit area which weight is appropriately determined in view of the strength, film thickness, weight, and handleability. The weight per unit area is, however, within a range of preferably 4 g/m² to 15 g/m², more preferably 4 g/m² to 12 g/m², even more preferably 5 g/m² to 10 g/m², so as to allow a nonaqueous electrolyte secondary battery to have a higher weight energy density and a higher volume energy density.

The porous film has an air permeability of preferably 30 sec/100 mL to 500 sec/100 mL, more preferably 50 sec/100 mL to 300 sec/100 mL, in terms of Gurley values. A porous film having an air permeability within the above range can have sufficient ion permeability.

The nonaqueous electrolyte secondary battery laminated separator in accordance with an embodiment of the present invention has an air permeability of preferably 30 sec/100 mL to 1000 sec/100 mL, more preferably 50 sec/100 mL to 800 sec/100 mL, in terms of Gurley values. The nonaqueous electrolyte secondary battery laminated separator, which has the above air permeability, allows the nonaqueous electrolyte secondary battery to have sufficient ion permeability.

The porous film has a porosity of preferably 20% by volume to 80% by volume, more preferably 30% by volume to 75% by volume, so as to (i) retain a larger amount of electrolyte and (ii) reliably prevent a flow of an excessively large electric current at a lower temperature. Further, in order to obtain sufficient ion permeability and prevent particles from entering the positive electrode and/or the negative electrode, the porous film has pores each having a pore diameter of preferably not larger than 0.30 μm, more preferably not larger than 0.14 μm, even more preferably not larger than 0.10 μm.

The method for producing the porous film is not limited to any particular one. For example, the method can include the following steps:

(A) Obtaining a polyolefin resin composition by kneading ultra-high molecular weight polyethylene, low molecular weight polyethylene having a weight-average molecular weight of not more than 10,000, a pore forming agent (such as calcium carbonate or plasticizer), and an antioxidant;

(B) Forming a sheet by rolling the obtained polyolefin resin composition with use of a pair of rollers, and gradually cooling the polyolefin resin composition while pulling the polyolefin resin composition with use of a winding roller rotating at a rate different from that of the pair of rollers;

(C) Removing the pore forming agent from the obtained sheet with use of an appropriate solvent; and

(D) Stretching, at an appropriate stretch magnification, the sheet from which the pore forming agent has been removed.

### Embodiment 2: Nonaqueous Electrolyte Secondary Battery Member, Nonaqueous Electrolyte Secondary Battery

The nonaqueous electrolyte secondary battery member in accordance with an embodiment of the present invention includes a positive electrode, the nonaqueous electrolyte secondary battery laminated separator in accordance with an embodiment of the present invention, and a negative electrode which are stacked in this order.

The nonaqueous electrolyte secondary battery member includes the nonaqueous electrolyte secondary battery laminated separator. Therefore, when the nonaqueous electrolyte secondary battery incorporating the nonaqueous electrolyte secondary battery member is used in a high voltage environment, it is possible to improve heat resistance and deterioration resistance of the nonaqueous electrolyte secondary battery.

The positive electrode, the nonaqueous electrolyte secondary battery laminated separator, and the negative electrode are as described above in Embodiment 1. The nonaqueous electrolyte secondary battery member can be prepared by stacking the positive electrode, the nonaqueous electrolyte secondary battery laminated separator in accordance with an embodiment of the present invention, and the negative electrode in this order.

<Positive Electrode>

Examples of the positive electrode include a positive electrode sheet having a structure in which an active material layer containing a positive electrode active material and a binding agent is formed on a current collector. The active material layer may further contain an electrically conductive agent.

The positive electrode active material is, for example, a material capable of being doped with and dedoped of lithium ions.

Examples of such a material include a lithium complex oxide containing at least one transition metal such as V, Ti, Cr, Mn, Fe, Co, Ni, or Cu. Example of the lithium complex oxide include a lithium complex oxide having a layer structure, a lithium complex oxide having a spinel structure, and a solid solution lithium-containing transition metal oxide constituted by a lithium complex oxide having both a layer structure and a spinel structure. Moreover, examples of the lithium complex oxide also include a lithium-cobalt complex oxide and a lithium-nickel complex oxide. Furthermore, examples of the lithium complex oxide also include lithium complex oxides in which one or some of transition metal atoms mainly constituting the above lithium complex oxides are substituted with other elements such as Na, K, B, F, Al, Ti, V, Cr, Mn, Fe, Co, Ni, Cu, Zn, Mg, Ca, Ga, Zr, Si, Nb, Mo, Sn and W.

Examples of the lithium complex oxide in which one or some of transition metal atoms mainly constituting the above lithium complex oxides are substituted with other elements include a lithium-cobalt complex oxide having a layer structure represented by a formula (2) below, a lithium-nickel complex oxide represented by a formula (3) below, a lithium-manganese complex oxide having a spinel structure represented by a formula (4) below, a solid solution lithium-containing transition metal oxide represented by a formula (5) below, and the like.

Li[Liₓ(Co₁₋ₐM¹ₐ)₁₋ₓ]O₂ (2)

(in the formula (2), M¹ is at least one metal selected from the group consisting of Na, K, B, F, Al, Ti, V, Cr, Mn, Fe, Ni, Cu, Zn, Mg, Ga, Zr, Si, Nb, Mo, Sn and W, and −0.1≤x≤0.30 and 0≤a≤0.5 are satisfied)

Li[Li_{y}(Ni_{1-b}M²_{b})_{1-y}]O₂ (3)

(in the formula (3), M² is at least one metal selected from the group consisting of Na, K, B, F, Al, Ti, V, Cr, Mn, Fe, Co, Cu, Zn, Mg, Ga, Zr, Si, Nb, Mo, Sn and W, and −0.1≤y≤0.30 and 0≤b≤0.5 are satisfied)

Li_{z}Mn_{2-c}M³_{c}O₄ (4)

(in the formula (4), M³ is at least one metal selected from the group consisting of Na, K, B, F, Al, Ti, V, Cr, Fe, Co, Ni, Cu, Zn, Mg, Ga, Zr, Si, Nb, Mo, Sn and W, and 0.9≤z and 0≤c≤1.5 are satisfied)

Li_{1+w}M⁴_{d}M⁵ₑO₂ (5)

(in the formula (5), each of M⁴ and M⁵ is at least one metal selected from the group consisting of Al, Ti, V, Cr, Mn, Fe, Co, Ni, Cu, Zn, Mg and Ca, and 0<w≤⅓, 0≤d≤⅔, 0≤e≤⅔, and w+d+e=1 are satisfied)

Specific examples of the lithium complex oxides represented by the formulae (2) through (5) include LiCoO₂, LiNiO₂, LiMnO₂, LiNi_{0.8}Co_{0.2}O₂, LiNi_{0.5}Mn_{0.5}O₂, LiNi_{0.85}Co_{0.10}Al_{0.05}O₂, LiNi_{0.8}Co_{0.15}Al_{0.05}O₂, LiNi_{0.5}Co_{0.2}Mn_{0.3}O₂, LiNi_{0.6}Co_{0.2}Mn_{0.2}O₂, LiNi_{0.33}CO_{0.33}Mn_{0.33}O₂, LiMn₂O₄, LiMn_{1.5}Ni_{0.5}O₄, LiMn_{1.5}Fe_{0.5}O₄, LiCoMnO₄, Li_{1.21}Ni_{0.20}Mn_{0.59}O₂, Li_{1.22}Ni_{0.20}Mn_{0.58}O₂, Li_{1.22}Ni_{0.15}Co_{0.10}Mn_{0.53}O₂, Li_{1.07}Ni_{0.35}Co_{0.08}Mn_{0.50}O₂, Li_{1.07}Ni_{0.36}CO_{0.08}Mn_{0.49}O₂, and the like.

Moreover, it is possible to preferably use, as a positive electrode active material, a lithium complex oxide other than the lithium complex oxides represented by the formulae (2) through (5). Examples of such a lithium complex oxide include LiNiVO₄, LiV₃O₆, Li_{1.2}Fe_{0.4}Mn_{0.4}O₂, and the like.

Examples of the material which can be preferably used as a positive electrode active material other than the lithium complex oxide include a phosphate having an olivine-type structure (such as a phosphate having an olivine-type structure represented by a formula (6) below).

Liᵥ(M⁶_{f}M⁷_{g}M⁸ₕM⁹ᵢ)ⱼPO₄ (6)

(in the formula (6), M⁶ is Mn, Co, or Ni, M⁷ is Ti, V, Cr, Mn, Fe, Co, Ni, Zr, Nb, or Mo, M⁸ is a transition metal arbitrarily excluding elements of the group VIA and the group VIIA or a representative element, M⁹ is a transition metal arbitrarily excluding elements of the group VIA and the group VIIA or a representative element, and 1.2≥a≥0.9, 1≥b≥0.6, 0.4≥c≥0, 0.2≥d≥0, 0.2≥e≥0, and 1.2≥f≥0.9 are satisfied)

In the positive electrode active material, each of surfaces of lithium metal complex oxide particles constituting the positive electrode active material is preferably coated with a coating layer. Examples of a material constituting the coating layer include a metal complex oxide, a metal salt, a boron-containing compound, a nitrogen-containing compound, a silicon-containing compound, a sulfur-containing compound, and the like. Among these, the metal complex oxide is suitably employed.

As the metal complex oxide, an oxide having lithium ion conductivity is suitably used. Example of such a metal complex oxide include a metal complex oxide constituted by Li and at least one element selected from the group consisting of Nb, Ge, Si, P, Al, W, Ta, Ti, S, Zr, Zn, V and B. When each of the particles of the positive electrode active material is coated with the coating layer, the coating layer inhibits side reaction at an interface between the positive electrode active material and the electrolyte under high voltage, and this makes it possible to achieve life extension of an obtained secondary battery. Moreover, it is possible to inhibit formation of a high-resistivity layer at the interface between the positive electrode active material and the electrolyte, and this makes it possible to achieve higher output of an obtained secondary battery.

<Nonaqueous Electrolyte>

Examples of the nonaqueous electrolyte include a nonaqueous electrolyte prepared by dissolving a lithium salt in an organic solvent. Examples of the lithium salt include LiClO₄, LiPF₆, LiAsF₆, LiSbF₆, LiBF₄, LiSO₃F, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (where BOB is bis(oxalato)borate), lower aliphatic carboxylic acid lithium salt, LiAlCl₄, and the like. These materials can be used alone, or two or more types of these can be used as a mixture. Among those lithium salts, it is preferable to use at least one lithium salt selected from the group consisting of LiPF₆, LiAsF₆, LiSbF₆, LiBF₄, LiSO₃F, LiCF₃SO₃, LiN(SO₂CF₃)₂ and LiC(SO₂CF₃)₃, each of which contains fluorine.

Examples of the organic solvent include carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and compounds each prepared by introducing a fluoro group into those organic solvents (i.e., compounds each prepared by substituting one or more hydrogen atoms of the organic solvent with fluorine atoms).

As the organic solvent, it is preferable to use two or more of those organic solvents in combination. Among those, it is preferable to employ a mixed solvent containing a carbonate, and it is further preferable to employ a mixed solvent containing a cyclic carbonate and an acyclic carbonate or a mixed solvent containing a cyclic carbonate and an ether. The mixed solvent containing a cyclic carbonate and an acyclic carbonate is preferably a mixed solvent containing ethylene carbonate, dimethyl carbonate, and ethyl methyl carbonate. The nonaqueous electrolyte containing such a mixed solvent has advantages of having a wide range of operating temperatures, being hardly deteriorated even when being used at a high voltage, being hardly deteriorated even when being used for a long period of time, and being hardly decomposed even when a graphite material such as natural graphite or artificial graphite is used as an active material of the negative electrode.

It is preferable to use, as the nonaqueous electrolyte, a nonaqueous electrolyte containing a lithium salt (such as LiPF₆) containing fluorine and an organic solvent including a fluorine substituent group, because such a nonaqueous electrolyte can enhance safety of an obtained nonaqueous electrolyte secondary battery. It is further preferable to use a mixed solvent containing a dimethyl carbonate and an ether (such as pentafluoropropyl methylether or 2,2,3,3-tetrafluoropropyl difluoro methylether) having a fluorine substituent group, because a high capacity maintenance ratio can be achieved even when the obtained nonaqueous electrolyte secondary battery is discharged at a high voltage.

<Negative Electrode>

Examples of the negative electrode include a negative electrode sheet having a structure in which an active material layer containing a negative electrode active material and a binding agent is formed on a current collector. The active material layer may further contain an electrically conductive agent.

<Negative Electrode Active Material>

Examples of the negative electrode active material include carbon materials, chalcogen compounds (such as oxide and sulfide), nitrides, metals, and alloys which can be doped with and dedoped of lithium ions at an electric potential lower than that for the positive electrode.

Examples of the carbon material which can be used as the negative electrode active material include graphites such as natural graphite and artificial graphite, cokes, carbon black, pyrolytic carbons, carbon fiber, and a fired product of an organic polymer compound.

Examples of the oxide which can be used as the negative electrode active material include oxides of silicon represented by a formula SiOₓ (where x is a positive real number) such as SiO₂ and SiO; oxides of titanium represented by a formula TiOₓ (where x is a positive real number) such as TiO₂ and TiO; oxides of vanadium represented by a formula VₓO_{y} (where each of x and y is a positive real number) such as V₂O₅ and VO₂; oxides of iron represented by a formula FeₓO_{y} (where each of x and y is a positive real number) such as Fe₃O₄, Fe₂O₃, and FeO; oxides of tin represented by a formula SnOₓ (where x is a positive real number) such as SnO₂ and SnO; oxides of tungsten represented by a general formula WOₓ (where x is a positive real number) such as WO₃ and WO₂; complex metal oxides (such as Li₄Ti₅O₁₂ and LiVO₂) containing lithium and titanium or vanadium; and the like.

Examples of the sulfide which can be used as the negative electrode active material include sulfides of titanium represented by a formula TiₓS_{y} (where each of x and y is a positive real number) such as Ti₂S₃, TiS₂, and TiS; sulfides of vanadium represented by a formula VSₓ (where x is a positive real number) such as V₃S₄, VS₂, and VS; sulfides of iron represented by a formula FeₓS_{y} (where each of x and y is a positive real number) such as Fe₃S₄, FeS₂, and FeS; sulfides of molybdenum represented by a formula MoₓS_{y} (where each of x and y is a positive real number) such as Mo₂S₃ and MoS₂; sulfides of tin represented by a formula SnSₓ (where x is a positive real number) such as SnS₂ and SnS; sulfides of tungsten represented by a formula WSₓ (where x is a positive real number) such as WS₂; sulfides of antimony represented by a formula SbₓS_{y} (where each of x and y is a positive real number) such as Sb₂S₃; sulfides of selenium represented by a formula SeₓS_{y} (where each of x and y is a positive real number) such as Se₅S₃, SeS₂, and SeS; and the like.

Examples of the nitride which can be used as the negative electrode active material include lithium-containing nitrides such as Li₃N and Li₃₋ₓAₓN (where A is one of or both of Ni and Co, and 0<x<3 is satisfied).

The carbon materials, oxides, sulfides, and nitrides can be used alone, or two or more types of those can be used in combination. The carbon materials, oxides, sulfides, and nitrides can each be a crystalline substance or an amorphous substance. The carbon materials, oxides, sulfides, and nitrides are each mainly supported by a negative electrode current collector so as to be used as an electrode.

Examples of the metal which can be used as the negative electrode active material include a lithium metal, a silicon metal, and a tin metal.

It is possible to employ a complex material which contains Si or Sn as a first constituent element and also contains second and third constituent elements. The second constituent element is, for example, at least one element selected from cobalt, iron, magnesium, titanium, vanadium, chromium, manganese, nickel, copper, zinc, gallium, and zirconium. The third constituent element is, for example, at least one element selected from boron, carbon, aluminum, and phosphorus.

In particular, in order to achieve high battery capacity and excellent battery characteristic, the metal material is preferably a simple substance of silicon or tin (which may contain a slight amount of impurities), SiOᵥ (0<v≤2), SnO_{w} (0≤w≤2), an Si—Co—C complex material, an Si—Ni—C complex material, an Sn—Co—C complex material, or an Sn—Ni—C complex material.

A nonaqueous electrolyte secondary battery in accordance with an embodiment of the present invention includes (i) a nonaqueous electrolyte secondary battery laminated separator in accordance with an embodiment of the present invention or (ii) a nonaqueous electrolyte secondary battery member in accordance with an embodiment of the present invention.

The nonaqueous electrolyte secondary battery can be produced by, for example, (i) producing a nonaqueous electrolyte secondary battery member by the above method, then (ii) inserting the nonaqueous electrolyte secondary battery member into a container that will serve as a housing of a nonaqueous electrolyte secondary battery, then (iii) filling the container with a nonaqueous electrolyte, and then (iv) hermetically sealing the container while reducing pressure inside the container.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss the present invention in further detail with reference to Examples and Comparative Examples. Note, however, that the present invention is not limited to those Examples.

<Test Method>

(1. Heat Resistance Test)

(1-1. Positive Electrode of Test Battery)

As the positive electrode, an electrode hoop available from Kabushiki Kaisha Hachiyama was purchased and used. The electrode hoop contained 92 parts by weight of LiNi_{0.5}Co_{0.2}Mn_{0.3}O₂ (which is a positive electrode active material), 5 parts by weight of an electrically conductive material, and 3 parts by weight of a binding agent, and had a thickness of 58 μm and a density of 2.5 g/cm³.

(1-2. Negative Electrode of Test Battery)

As the negative electrode, an electrode hoop available from Kabushiki Kaisha Hachiyama was purchased and used. The electrode hoop contained 98 parts by weight of natural graphite, 1 part by weight of a binding agent, and 1 part by weight of carboxymethyl cellulose, and had a thickness of 48 μm and a density of 1.5 g/cm³.

(1-3. Preparation of Test Battery)

In a laminate pouch, the positive electrode, the nonaqueous electrolyte secondary battery laminated separator, and the negative electrode were stacked (arranged) in this order so that (i) the porous layer of each of the nonaqueous electrolyte secondary battery laminated separators prepared by Examples and Comparative Examples below and the positive electrode active material layer of the positive electrode come into contact with each other and (ii) the polyethylene porous film of each of the nonaqueous electrolyte secondary battery laminated separators and the negative electrode active material layer of the negative electrode come into contact with each other. This produced a nonaqueous electrolyte secondary battery member.

In this case, the positive electrode and the negative electrode were arranged such that the entire surface of the positive electrode active material layer of the positive electrode makes contact with the surface of the porous layer and a portion which is of the surface of the porous layer and does not make contact with the surface of the positive electrode active material layer makes contact with a portion which is of the positive electrode and in which the positive electrode active material layer is not formed. Consequently, the portion which is of the surface of the porous layer and does not make contact with the surface of the positive electrode active material layer was arranged so as to surround, like a frame, the positive electrode active material layer.

Subsequently, the nonaqueous electrolyte secondary battery member was put into a bag made of a laminate of an aluminum layer and a heat seal layer. Further, 230 μL of nonaqueous electrolyte was put into the bag. The nonaqueous electrolyte was prepared by dissolving LiPF₆ in a mixed solvent of ethylene carbonate, ethyl methyl carbonate, and diethyl carbonate at a ratio of 3:5:2 (volume ratio) so that the LiPF₆ is contained at 1 mol/L.

The bag was then heat-sealed while pressure inside the bag was reduced, so that a nonaqueous electrolyte secondary battery was prepared.

(1-4. Trickle Charging)

A nonaqueous electrolyte secondary battery prepared using a nonaqueous electrolyte secondary battery laminated separator prepared in each of Examples and Comparative Examples was subjected to constant-current charging up to 4.5 V (i.e., 4.6 V (vs Li/Li⁺)) at an electric current of 1 C at 25° C., and was then subjected to trickle charging under conditions of 4.5 V (i.e., 4.6 V (vs Li/Li⁺)) and 25° C. for 168 hours, with use of a charge/discharge tester available from TOYO SYSTEM CO., LTD.

After completion of trickle charging, the test battery was disassembled and the nonaqueous electrolyte secondary battery laminated separator was taken out. A color of the porous layer surface prior to trickle charging and a color of the porous layer surface which had been in contact with the positive electrode active material layer during the trickle charging were visually observed and compared to each other.

(1-5. Metal Stick Piercing Test)

As explained in Step 4 in Embodiment 1, with use of the solder test apparatus shown in FIG. 1, the nonaqueous electrolyte secondary battery laminated separator which had been subjected to the trickle charging was pierced with a metal stick having a temperature of 450° C. and a diameter of 2.2 mm from a side on which the porous layer had been in contact with the positive electrode active material layer. A time from when a tip of the metal stick came into contact with the surface of the porous layer to when the tip was brought away from the surface was 10 seconds. After completion of the metal stick piercing test, an area of an opening in the nonaqueous electrolyte secondary battery laminated separator was determined. The area of the opening was measured with a digital microscope VHX-5000 available from Keyence Corporation with use of accompanying image analysis software.

(2. Measurement of IR Intensity)

IR intensity on the porous layer surface of the nonaqueous electrolyte secondary battery laminated separator prepared in each of Examples and Comparative Examples was measured by the ATR-IR method to determine maximum peak intensity (X1) in a range of 1490 cm⁻¹ to 1530 cm⁻¹. As the apparatus, Cary600 FTIR available from Agilent was used.

Moreover, for the nonaqueous electrolyte secondary battery laminated separator taken out from the disassembled test battery after completion of the trickle charging, IR intensity on the portion which was of the surface of the porous layer and had been in contact with the positive electrode active material layer was measured by the ATR-IR method to determine maximum peak intensity (X2) in a range of 1490 cm⁻¹ to 1530 cm⁻¹. In addition, a value of (X2/X1)×100 was calculated.

### Example 1

(1. Preparation of Coating Solution)

A 500-mL separable flask having a stirring blade, a thermometer, a nitrogen incurrent canal, and a powder addition port was used. Nitrogen was introduced into the flask to thoroughly dry the flask. Then, 409.2 g of N-methyl-2-pyrrolidone (hereinafter abbreviated as “NMP”) as an organic solvent was put into the flask. In addition, 30.8 g of calcium chloride was added as chloride (for 2 hours at 200° C., using vacuum drying), and a temperature was raised to 100° C. to completely dissolve the calcium chloride. Then, a temperature of the obtained solution was returned to room temperature (25° C.), and a water content of the solution was adjusted to 500 ppm. Next, 18.11 g of 2-chloro-1,4-phenylenediamine as an aromatic diamine was added and completely dissolved. While stirring this solution while keeping the temperature at 20±2° C., 25.19 g of terephthalic dichloride (hereinafter abbreviated as “TPC”) as an acid chloride was added.

Through the method, an aramid resin 1 having the following properties was obtained: a chloro group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 2.28 dL/g.

To a solution of the obtained aramid resin 1, 100 parts by weight of alumina powder having an average particle diameter of 0.02 μm and 100 parts by weight of alumina powder having an average particle diameter of 0.7 μm were added. Subsequently, NMP was added to the solution and diluted to prepare a coating liquid 1 in which a total concentration of the aramid resin 1 and a filler was 6% by weight. In this case, in order that a content of the filler in the porous layer became 66% by weight, the coating liquid 1 was obtained by mixing the aramid resin 1, the filler, and the solvent while setting a content of the filler to be 66% by weight, where a weight of the aramid resin 1 and the filler was 100% by weight.

(2. Preparation of Nonaqueous Electrolyte Secondary Battery Laminated Separator)

One surface of a porous film base material, which had been obtained by stretching a polyolefin resin composition constituted by ultra-high molecular weight polyethylene, was coated with the coating liquid 1 with use of a gravure coater, and the coating liquid 1 was dried to precipitate the aramid resin 1 contained in the coating liquid 1. Thus, a nonaqueous electrolyte secondary battery laminated separator 1 was obtained in which a porous layer was formed on a surface of the base material.

(3. Heat Resistance Test, Etc.)

The nonaqueous electrolyte secondary battery laminated separator 1 was subjected to the test described in <Test method> above. Tables 1 and 2 show the results.

### Example 2

(1. Preparation of Coating Solution)

An aramid resin 2 was obtained by a process similar to that of Example 1, except that an added amount of 2-chloro-1,4-phenylenediamine as aromatic diamine was set to 7.46 g, and an added amount of TPC as acid chloride was set to 10.30 g. The aramid resin 2 had the following properties: a chloro group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 1.47 dL/g.

To a solution of the obtained aramid resin 2, 100 parts by weight of alumina powder having an average particle diameter of 0.02 μm and 100 parts by weight of alumina powder having an average particle diameter of 0.7 μm were added. Subsequently, NMP was added to the solution and diluted to prepare a coating liquid 2 in which a total concentration of the aramid resin 2 and a filler was 6% by weight. In this case, in order that a content of the filler in the porous layer became 66% by weight, the coating liquid 2 was obtained by mixing the aramid resin 2, the filler, and the solvent while setting a content of the filler to be 66% by weight, where a weight of the aramid resin 2 and the filler was 100% by weight.

(2. Preparation of Nonaqueous Electrolyte Secondary Battery Laminated Separator, Heat Resistance Test, Etc.)

A nonaqueous electrolyte secondary battery laminated separator 2 was obtained by a process similar to that of Example 1, except that the coating liquid 2 was used instead of the coating liquid 1. The nonaqueous electrolyte secondary battery laminated separator 2 was subjected to the test described in <Test method> above. Tables 1 and 2 show the results.

### Example 3

(1. Preparation of Coating Solution)

An aramid resin 3 was obtained by a process similar to that of Example 1, except that an added amount of 2-chloro-1,4-phenylenediamine as aromatic diamine was set to 2.49 g, and an added amount of TPC as acid chloride was set to 3.51 g. The aramid resin 3 had the following properties: a chloro group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 3.85 dL/g.

To a solution of the obtained aramid resin 3, 100 parts by weight of alumina powder having an average particle diameter of 0.02 μm and 100 parts by weight of alumina powder having an average particle diameter of 0.7 μm were added. Subsequently, NMP was added to the solution and diluted to prepare a coating liquid 3 in which a total concentration of the aramid resin 3 and a filler was 2.87% by weight. In this case, in order that a content of the filler in the porous layer became 66% by weight, the coating liquid 3 was obtained by mixing the aramid resin 3, the filler, and the solvent while setting a content of the filler to be 66% by weight, where a weight of the aramid resin 3 and the filler was 100% by weight.

(2. Preparation of Nonaqueous Electrolyte Secondary Battery Laminated Separator, Heat Resistance Test, Etc.)

A nonaqueous electrolyte secondary battery laminated separator 3 was obtained by a process similar to that of Example 1, except that the coating liquid 3 was used instead of the coating liquid 1. The nonaqueous electrolyte secondary battery laminated separator 3 was subjected to the test described in <Test method> above. Tables 1 and 2 show the results.

### Example 4

(1. Preparation of Coating Solution)

An aramid resin 4 was obtained by a process similar to that of Example 1, except that an added amount of 2-cyano-1,4-phenylenediamine as aromatic diamine was set to 5.40 g, and an added amount of TPC as acid chloride was set to 8.15 g. The aramid resin 4 had the following properties: a cyano group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 2.62 dL/g.

To a solution of the obtained aramid resin 4, 100 parts by weight of alumina powder having an average particle diameter of 0.02 μm and 100 parts by weight of alumina powder having an average particle diameter of 0.7 μm were added. Subsequently, NMP was added to the solution and diluted to prepare a coating liquid 4 in which a total concentration of the aramid resin 4 and a filler was 3.00% by weight. In this case, in order that a content of the filler in the porous layer became 66% by weight, the coating liquid 4 was obtained by mixing the aramid resin 4, the filler, and the solvent while setting a content of the filler to be 66% by weight, where a weight of the aramid resin 4 and the filler was 100% by weight.

(2. Preparation of Nonaqueous Electrolyte Secondary Battery Laminated Separator, Heat Resistance Test, Etc.)

A nonaqueous electrolyte secondary battery laminated separator 4 was obtained by a process similar to that of Example 1, except that the coating liquid 4 was used instead of the coating liquid 1. The nonaqueous electrolyte secondary battery laminated separator 4 was subjected to the test described in <Test method> above. Tables 1 and 2 show the results.

### Example 5

(1. Preparation of Coating Solution)

An aramid resin 5 was obtained by a process similar to that of Example 1, except that an added amount of 2-chloro-1,4-phenylenediamine as aromatic diamine was set to 5.53 g, an added amount of paraphenylenediamine as aromatic diamine was set to 5.53 g, and an added amount of TPC as acid chloride was set to 9.38 g. The aramid resin 5 had the following properties: a chloro group was contained as an electron-withdrawing group in each of aromatic rings in a main chain; amino groups were contained at both ends of a molecule; 100% of bonds connecting the aromatic rings in the main chain were amide bonds; 75% of aromatic diamine-derived units had electron-withdrawing groups; acid chloride-derived units had no electron-withdrawing groups; and an intrinsic viscosity was 1.55 dL/g.

To a solution of the obtained aramid resin 5, 100 parts by weight of alumina powder having an average particle diameter of 0.02 μm and 100 parts by weight of alumina powder having an average particle diameter of 0.7 μm were added. Subsequently, NMP was added to the solution and diluted to prepare a coating liquid 5 in which a total concentration of the aramid resin 5 and a filler was 2.21% by weight. In this case, in order that a content of the filler in the porous layer became 66% by weight, the coating liquid 5 was obtained by mixing the aramid resin 5, the filler, and the solvent while setting a content of the filler to be 66% by weight, where a weight of the aramid resin 5 and the filler was 100% by weight.

(2. Preparation of Nonaqueous Electrolyte Secondary Battery Laminated Separator, Heat Resistance Test, Etc.)

A nonaqueous electrolyte secondary battery laminated separator 5 was obtained by a process similar to that of Example 1, except that the coating liquid 5 was used instead of the coating liquid 1. The nonaqueous electrolyte secondary battery laminated separator 5 was subjected to the test described in <Test method> above. Tables 1 and 2 show the results.

### Example 6

(1. Preparation of Coating Solution)

An aramid resin 6 was obtained by a process similar to that of Example 1, except that an added amount of 2-chloro-1,4-phenylenediamine as aromatic diamine was set to 3.72 g, an added amount of paraphenylenediamine as aromatic diamine was set to 2.81 g, and an added amount of TPC as acid chloride was set to 10.48 g. The aramid resin 6 had the following properties: a chloro group was contained as an electron-withdrawing group in each of aromatic rings in a main chain; amino groups were contained at both ends of a molecule; 100% of bonds connecting the aromatic rings in the main chain were amide bonds; 50% of aromatic diamine-derived units had electron-withdrawing groups; acid chloride-derived units had no electron-withdrawing groups; and an intrinsic viscosity was 3.67 dL/g.

To a solution of the obtained aramid resin 6, 100 parts by weight of alumina powder having an average particle diameter of 0.02 μm and 100 parts by weight of alumina powder having an average particle diameter of 0.7 μm were added. Subsequently, NMP was added to the solution and diluted to prepare a coating liquid 6 in which a total concentration of the aramid resin 6 and a filler was 2.15% by weight. In this case, in order that a content of the filler in the porous layer became 66% by weight, the coating liquid 6 was obtained by mixing the aramid resin 6, the filler, and the solvent while setting a content of the filler to be 66% by weight, where a weight of the aramid resin 6 and the filler was 100% by weight.

(2. Preparation of Nonaqueous Electrolyte Secondary Battery Laminated Separator, Heat Resistance Test, Etc.)

A nonaqueous electrolyte secondary battery laminated separator 6 was obtained by a process similar to that of Example 1, except that the coating liquid 6 was used instead of the coating liquid 1. The nonaqueous electrolyte secondary battery laminated separator 6 was subjected to the test described in <Test method> above. Tables 1 and 2 show the results.

### Example 7

(1. Preparation of Coating Solution)

An aramid resin 7 was obtained by a process similar to that of Example 1, except that an added amount of 2-chloro-1,4-phenylenediamine as aromatic diamine was set to 84.83 g, and an added amount of TPC as acid chloride was set to 117.05 g. The aramid resin 7 had the following properties: a chloro group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 2.40 dL/g.

To a solution of the obtained aramid resin 7, alumina powder having an average particle diameter of 0.02 μm was added. Subsequently, NMP was added to the solution and diluted to prepare a coating liquid 7 in which a total concentration of the aramid resin 7 and a filler was 4.00% by weight. In this case, in order that a content of the filler in the porous layer became 50% by weight, the coating liquid 7 was obtained by mixing the aramid resin 7, the filler, and the solvent while setting a content of the filler to be 50% by weight, where a weight of the aramid resin 7 and the filler was 100% by weight.

(2. Preparation of Nonaqueous Electrolyte Secondary Battery Laminated Separator, Heat Resistance Test, Etc.)

A nonaqueous electrolyte secondary battery laminated separator 7 was obtained by a process similar to that of Example 1, except that the coating liquid 7 was used instead of the coating liquid 1. The nonaqueous electrolyte secondary battery laminated separator 7 was subjected to the test described in <Test method> above. Tables 1 and 2 show the results.

### Example 8

(1. Preparation of Coating Solution)

An aramid resin 8 was obtained by a process similar to that of Example 1, except that an added amount of 2-chloro-1,4-phenylenediamine as aromatic diamine was set to 6.98 g, an added amount of paraphenylenediamine as aromatic diamine was set to 5.15 g, and an added amount of TPC as acid chloride was set to 19.06 g. The aramid resin 8 had the following properties: a chloro group was contained as an electron-withdrawing group in each of aromatic rings in a main chain; amino groups were contained at both ends of a molecule; 100% of bonds connecting the aromatic rings in the main chain were amide bonds; 50% of aromatic diamine-derived units had electron-withdrawing groups; acid chloride-derived units had no electron-withdrawing groups; and an intrinsic viscosity was 1.90 dL/g.

To a solution of the obtained aramid resin 8, alumina powder having an average particle diameter of 0.02 μm was added. Subsequently, NMP was added to the solution and diluted to prepare a coating liquid 8 in which a total concentration of the aramid resin 8 and a filler was 3.00% by weight. In this case, in order that a content of the filler in the porous layer became 40% by weight, the coating liquid 8 was obtained by mixing the aramid resin 8, the filler, and the solvent while setting a content of the filler to be 40% by weight, where a weight of the aramid resin 8 and the filler was 100% by weight.

(2. Preparation of Nonaqueous Electrolyte Secondary Battery Laminated Separator, Heat Resistance Test, Etc.)

A nonaqueous electrolyte secondary battery laminated separator 8 was obtained by a process similar to that of Example 1, except that the coating liquid 8 was used instead of the coating liquid 1. The nonaqueous electrolyte secondary battery laminated separator 8 was subjected to the test described in <Test method> above. Tables 1 and 2 show the results.

### Comparative Example 1

(1. Preparation of Coating Solution)

A comparative aramid resin 1 was obtained by a process similar to that of Example 1, except that an added amount of 2-chloro-1,4-phenylenediamine as aromatic diamine was set to 3.72 g, an added amount of paraphenylenediamine as aromatic diamine was set to 2.79 g, and an added amount of TPC as acid chloride was set to 9.45 g. The comparative aramid resin 1 had the following properties: a chloro group was contained as an electron-withdrawing group in each of aromatic rings in a main chain; amino groups were contained at both ends of a molecule; 100% of bonds connecting the aromatic rings in the main chain were amide bonds; 50% of aromatic diamine-derived units had electron-withdrawing groups; acid chloride-derived units had no electron-withdrawing groups; and an intrinsic viscosity was 1.10 dL/g.

To a solution of the obtained comparative aramid resin 1, 100 parts by weight of alumina powder having an average particle diameter of 0.02 μm and 100 parts by weight of alumina powder having an average particle diameter of 0.7 μm were added. Subsequently, NMP was added to the solution and diluted to prepare a comparative coating liquid 1 in which a total concentration of the comparative aramid resin 1 and a filler was 4.51% by weight. In this case, in order that a content of the filler in the porous layer became 66% by weight, the comparative coating liquid 1 was obtained by mixing the comparative aramid resin 1, the filler, and the solvent while setting a content of the filler to be 66% by weight, where a weight of the comparative aramid resin 1 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 1 was obtained by a process similar to that of Example 1, except that the comparative coating liquid 1 was used instead of the coating liquid 1. The comparative nonaqueous electrolyte secondary battery laminated separator 1 was subjected to the test described in <Test method> above. Tables 1 and 2 show the results.

### Comparative Example 2

(1. Preparation of Coating Solution)

A comparative aramid resin 2 was obtained by a process similar to that of Example 1, except that an added amount of 2-chloro-1,4-phenylenediamine as aromatic diamine was set to 1.86 g, an added amount of paraphenylenediamine as aromatic diamine was set to 4.24 g, and an added amount of TPC as acid chloride was set to 9.50 g. The comparative aramid resin 2 had the following properties: a chloro group was contained as an electron-withdrawing group in each of aromatic rings in a main chain; amino groups were contained at both ends of a molecule; 100% of bonds connecting the aromatic rings in the main chain were amide bonds; 25% of aromatic diamine-derived units had electron-withdrawing groups; acid chloride-derived units had no electron-withdrawing groups; and an intrinsic viscosity was 0.66 dL/g.

To a solution of the obtained comparative aramid resin 2, 100 parts by weight of alumina powder having an average particle diameter of 0.02 μm and 100 parts by weight of alumina powder having an average particle diameter of 0.7 μm were added. Subsequently, NMP was added to the solution and diluted to prepare a comparative coating liquid 2 in which a total concentration of the comparative aramid resin 2 and a filler was 4.51% by weight. In this case, in order that a content of the filler in the porous layer became 66% by weight, the comparative coating liquid 2 was obtained by mixing the comparative aramid resin 2, the filler, and the solvent while setting a content of the filler to be 66% by weight, where a weight of the comparative aramid resin 2 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 2 was obtained by a process similar to that of Example 1, except that the comparative coating liquid 2 was used instead of the coating liquid 1. The comparative nonaqueous electrolyte secondary battery laminated separator 2 was subjected to the test described in <Test method> above. Tables 1 and 2 show the results.

### Comparative Example 3

A comparative aramid resin 3 was used which had the following properties: no electron-withdrawing group was contained in each of aromatic rings in a main chain; amino groups were contained at both ends of a molecule; 100% of bonds connecting the aromatic rings in the main chain were amide bonds; aromatic diamine-derived units had no electron-withdrawing groups; acid chloride-derived units had no electron-withdrawing groups; and an intrinsic viscosity was 1.90 dL/g.

To a solution of the comparative aramid resin 3, alumina powder having an average particle diameter of 0.7 μm was added. Subsequently, NMP was added to the solution and diluted to prepare a comparative coating liquid 3. In this case, in order that a content of the filler in the porous layer became 90% by weight, the comparative coating liquid 3 was obtained by mixing the comparative aramid resin 3, the filler, and the solvent while setting a content of the filler to be 90% by weight, where a weight of the comparative aramid resin 3 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 3 was obtained by a process similar to that of Example 1, except that the comparative coating liquid 3 was used instead of the coating liquid 1. The comparative nonaqueous electrolyte secondary battery laminated separator 3 was subjected to the test described in <Test method> above. Tables 1 and 2 show the results.

### Comparative Example 4

(1. Preparation of Coating Solution)

A comparative aramid resin 4 was obtained by a process similar to that of Example 1, except that an added amount of 2-chloro-1,4-phenylenediamine as aromatic diamine was set to 7.44 g, and an added amount of TPC as acid chloride was set to 10.29 g. The comparative aramid resin 4 had the following properties: a chloro group was contained as an electron-withdrawing group in each of aromatic rings in a main chain; amino groups were contained at both ends of a molecule; 100% of bonds connecting the aromatic rings in the main chain were amide bonds; 100% of aromatic diamine-derived units had electron-withdrawing groups; acid chloride-derived units had no electron-withdrawing groups; and an intrinsic viscosity was 2.40 dL/g.

To a solution of the obtained comparative aramid resin 4, alumina powder having an average particle diameter of 0.7 μm was added. Subsequently, NMP was added to the solution and diluted to prepare a comparative coating liquid 4. In this case, in order that a content of the filler in the porous layer became 90% by weight, the comparative coating liquid 4 was obtained by mixing the comparative aramid resin 4, the filler, and the solvent while setting a content of the filler to be 90% by weight, where a weight of the comparative aramid resin 4 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 4 was obtained by a process similar to that of Example 1, except that the comparative coating liquid 4 was used instead of the coating liquid 1. The comparative nonaqueous electrolyte secondary battery laminated separator 4 was subjected to the test described in <Test method> above. Tables 1 and 2 show the results.

### Comparative Example 5

(1. Preparation of Coating Solution)

A comparative aramid resin 5 was obtained by a process similar to that of Example 1, except that an added amount of paraphenylenediamine as aromatic diamine was set to 13.25 g, an added amount of TPC as acid chloride was set to 24.27 g, and 5.09 g of benzoyl chloride was added last for sealing the ends. The comparative aramid resin 5 had the following properties: no electron-withdrawing group is contained in each of aromatic rings in a main chain; no amino groups were contained at both ends of a molecule; 100% of bonds connecting the aromatic rings in the main chain were amide bonds; aromatic diamine-derived units had no electron-withdrawing groups; acid chloride-derived units had no electron-withdrawing groups; and an intrinsic viscosity was 1.78 dL/g.

To a solution of the obtained comparative aramid resin 5, 100 parts by weight of alumina powder having an average particle diameter of 0.02 μm and 100 parts by weight of alumina powder having an average particle diameter of 0.7 μm were added. Subsequently, NMP was added to the solution and diluted to prepare a comparative coating liquid 5 in which a total concentration of the comparative aramid resin 5 and a filler was 6.0% by weight. In this case, in order that a content of the filler in the porous layer became 66% by weight, the comparative coating liquid 5 was obtained by mixing the comparative aramid resin 5, the filler, and the solvent while setting a content of the filler to be 66% by weight, where a weight of the comparative aramid resin 5 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 5 was obtained by a process similar to that of Example 1, except that the comparative coating liquid 5 was used instead of the coating liquid 1. The comparative nonaqueous electrolyte secondary battery laminated separator 5 was subjected to the test described in <Test method> above. Tables 1 and 2 show the results.

### Comparative Example 6

(1. Preparation of Coating Solution)

A comparative aramid resin 6 was obtained by a process similar to that of Example 1, except that an added amount of paraphenylenediamine as aromatic diamine was set to 12.77 g, an added amount of TPC as acid chloride was set to 24.71 g, and 0.85 g of 4-aminobenzonitrile was used as aniline for sealing the ends. The comparative aramid resin 6 had the following properties: no electron-withdrawing group is contained in each of aromatic rings in a main chain; no amino groups were contained at both ends of a molecule; 100% of bonds connecting the aromatic rings in the main chain were amide bonds; aromatic diamine-derived units had no electron-withdrawing groups; acid chloride-derived units had no electron-withdrawing groups; and an intrinsic viscosity was 0.73 dL/g.

To a solution of the obtained comparative aramid resin 6, 100 parts by weight of alumina powder having an average particle diameter of 0.02 μm and 100 parts by weight of alumina powder having an average particle diameter of 0.7 μm were added. Subsequently, NMP was added to the solution and diluted to prepare a comparative coating liquid 6 in which a total concentration of the comparative aramid resin 6 and a filler was 6.0% by weight. In this case, in order that a content of the filler in the porous layer became 66% by weight, the comparative coating liquid 6 was obtained by mixing the comparative aramid resin 6, the filler, and the solvent while setting a content of the filler to be 66% by weight, where a weight of the comparative aramid resin 6 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 6 was obtained by a process similar to that of Example 1, except that the comparative coating liquid 6 was used instead of the coating liquid 1. The comparative nonaqueous electrolyte secondary battery laminated separator 6 was subjected to the test described in <Test method> above. Tables 1 and 2 show the results.

### Comparative Example 7

(1. Preparation of Coating Solution)

A comparative aramid resin 7 was obtained by a process similar to that of Example 1, except that an added amount of 2-chloro-1,4-phenylenediamine as aromatic diamine was set to 1.87 g, an added amount of paraphenylenediamine as aromatic diamine was set to 4.22 g, and an added amount of TPC as acid chloride was set to 10.51 g. The comparative aramid resin 7 had the following properties: a chloro group was contained as an electron-withdrawing group in each of aromatic rings in a main chain; amino groups were contained at both ends of a molecule; 100% of bonds connecting the aromatic rings in the main chain were amide bonds; 25% of aromatic diamine-derived units had electron-withdrawing groups; acid chloride-derived units had no electron-withdrawing groups; and an intrinsic viscosity was 3.55 dL/g.

To a solution of the obtained comparative aramid resin 7, 100 parts by weight of alumina powder having an average particle diameter of 0.02 μm and 100 parts by weight of alumina powder having an average particle diameter of 0.7 μm were added. Subsequently, NMP was added to the solution and diluted to prepare a comparative coating liquid 7 in which a total concentration of the comparative aramid resin 7 and a filler was 2.21% by weight. In this case, in order that a content of the filler in the porous layer became 66% by weight, the comparative coating liquid 7 was obtained by mixing the comparative aramid resin 7, the filler, and the solvent while setting a content of the filler to be 66% by weight, where a weight of the comparative aramid resin 7 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 7 was obtained by a process similar to that of Example 1, except that the comparative coating liquid 7 was used instead of the coating liquid 1. The comparative nonaqueous electrolyte secondary battery laminated separator 7 was subjected to the test described in <Test method> above. Tables 1 and 2 show the results.

### Comparative Example 8

(1. Preparation of Coating Solution)

A comparative aramid resin 8 was obtained by a process similar to that of Example 1, except that an added amount of 2-chloro-1,4-phenylenediamine as aromatic diamine was set to 11.20 g, and an added amount of 4,4′-oxybis(benzoyl chloride) as acid chloride was set to 10.51 g. The comparative aramid resin 8 had the following properties: a chloro group was contained as an electron-withdrawing group in each of aromatic rings in a main chain; amino groups were contained at both ends of a molecule; 66% of bonds connecting the aromatic rings in the main chain were amide bonds; 100% of aromatic diamine-derived units had electron-withdrawing groups; acid chloride-derived units had no electron-withdrawing groups; and an intrinsic viscosity was 1.50 dL/g.

To a solution of the obtained comparative aramid resin 8, alumina powder having an average particle diameter of 0.02 μm was added. Subsequently, NMP was added to the solution and diluted to prepare a comparative coating liquid 8 in which a total concentration of the comparative aramid resin 8 and a filler was 6.00% by weight. In this case, in order that a content of the filler in the porous layer became 50% by weight, the comparative coating liquid 8 was obtained by mixing the comparative aramid resin 8, the filler, and the solvent while setting a content of the filler to be 50% by weight, where a weight of the comparative aramid resin 8 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 8 was obtained by a process similar to that of Example 1, except that the comparative coating liquid 8 was used instead of the coating liquid 1. The comparative nonaqueous electrolyte secondary battery laminated separator 8 was subjected to the test described in <Test method> above. Tables 1 and 2 show the results.

### Comparative Example 9

(1. Preparation of Coating Solution)

A comparative aramid resin 9 was obtained by a process similar to that of Example 1, except that an added amount of 4,4′-diaminodiphenyl ether as aromatic diamine was set to 17.31 g, and an added amount of TPC as acid chloride was set to 17.38 g. The comparative aramid resin 9 had the following properties: no electron-withdrawing group was contained in each of aromatic rings in a main chain; amino groups were contained at both ends of a molecule; 66% of bonds connecting the aromatic rings in the main chain were amide bonds; aromatic diamine-derived units had no electron-withdrawing groups; acid chloride-derived units had no electron-withdrawing groups; and an intrinsic viscosity was 1.65 dL/g.

To a solution of the obtained comparative aramid resin 9, alumina powder having an average particle diameter of 0.02 μm was added. Subsequently, NMP was added to the solution and diluted to prepare a comparative coating liquid 9 in which a total concentration of the comparative aramid resin 9 and a filler was 6.00% by weight. In this case, in order that a content of the filler in the porous layer became 50% by weight, the comparative coating liquid 9 was obtained by mixing the comparative aramid resin 9, the filler, and the solvent while setting a content of the filler to be 50% by weight, where a weight of the comparative aramid resin 9 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 9 was obtained by a process similar to that of Example 1, except that the comparative coating liquid 9 was used instead of the coating liquid 1. The comparative nonaqueous electrolyte secondary battery laminated separator 9 was subjected to the test described in <Test method> above. Tables 1 and 2 show the results.

### Comparative Example 10

(1. Preparation of Coating Solution)

A comparative aramid resin 10 was obtained by a process similar to that of Example 1, except that an added amount of 2-chloro-1,4-phenylenediamine as aromatic diamine was set to 6.98 g, an added amount of paraphenylenediamine was set to 5.15 g, and an added amount of TPC as acid chloride was set to 19.06 g. The comparative aramid resin 10 had the following properties: a chloro group was contained as an electron-withdrawing group in each of aromatic rings in a main chain; amino groups were contained at both ends of a molecule; 100% of bonds connecting the aromatic rings in the main chain were amide bonds; 50% of aromatic diamine-derived units had electron-withdrawing groups; acid chloride-derived units had no electron-withdrawing groups; and an intrinsic viscosity was 1.90 dL/g.

To a solution of the obtained comparative aramid resin 10, alumina powder having an average particle diameter of 0.02 μm was added. Subsequently, NMP was added to the solution and diluted to prepare a coating liquid 10 in which a total concentration of the comparative aramid resin 10 and a filler was 3.00% by weight. In this case, in order that a content of the filler in the porous layer became 20% by weight, the coating liquid 10 was obtained by mixing the comparative aramid resin 10, the filler, and the solvent while setting a content of the filler to be 20% by weight, where a weight of the comparative aramid resin 10 and the filler was 100% by weight.

(2. Preparation of Nonaqueous Electrolyte Secondary Battery Laminated Separator, Heat Resistance Test, Etc.)

A comparative nonaqueous electrolyte secondary battery laminated separator 10 was obtained by a process similar to that of Example 1, except that the comparative coating liquid 10 was used instead of the coating liquid 1. However, pores were not sufficiently formed in the porous layer, and the test described in <Test method> above could not be carried out. Tables 1 and 2 show the results.

TABLE 1

| | Electron- | | | | Ratio | Filler | | |
|---|---|---|---|---|---|---|---|---|
| | withdrawing | | Withdrawing | Presence | of | content | | |
| | group in | Withdrawing | group | or | aromatic | in | | Weight |
| | aromatic | group | content | absence | ring | porous | Aramid | per |
| | ring in | content in | in acid | of end | connecting | layer | intrinsic | unit |
| | main | diamine | chloride | amino | amide | (% by | viscosity | area |
| | chain | unit (%) | unit (%) | group | group (%) | mass) | (dL/g) | (g/m²) |
| Example 1 | Cl | 100 | 0 | ∘ | 100 | 66 | 2.28 | 1.9 |
| Example 2 | Cl | 100 | 0 | ∘ | 100 | 66 | 1.47 | 2.6 |
| Example 3 | Cl | 100 | 0 | ∘ | 100 | 66 | 3.85 | 2.7 |
| Example 4 | CN | 100 | 0 | ∘ | 100 | 66 | 2.62 | 0.5 |
| Exampie 5 | Cl | 75 | 0 | ∘ | 100 | 66 | 1.55 | 1.9 |
| Example 6 | Cl | 50 | 0 | ∘ | 100 | 66 | 3.67 | 2.0 |
| Example 7 | Cl | 100 | 0 | ∘ | 100 | 50 | 2.40 | 1.3 |
| Example 8 | Cl | 50 | 0 | ∘ | 100 | 40 | 1.90 | 1.5 |
| Comparative | Cl | 50 | 0 | ∘ | 100 | 66 | 1.10 | 1.8 |
| Example 1 | | | | | | | | |
| Comparative | Cl | 25 | 0 | ∘ | 100 | 66 | 0.66 | 1.8 |
| Example 2 | | | | | | | | |
| Comparative | None | 0 | 0 | ∘ | 100 | 90 | 1.90 | 2.0 |
| Example 3 | | | | | | | | |
| Comparative | Cl | 100 | 0 | ∘ | 100 | 90 | 2.40 | 2.0 |
| Example 4 | | | | | | | | |
| Comparative | None | 0 | 0 | x | 100 | 66 | 1.78 | 2.2 |
| Example 5 | | | | | | | | |
| Comparative | None | 0 | 0 | x | 100 | 66 | 0.73 | 4.2 |
| Example 6 | | | | | | | | |
| Comparative | Cl | 25 | 0 | ∘ | 100 | 66 | 3.55 | 1.5 |
| Example 7 | | | | | | | | |
| Comparative | Cl | 100 | 0 | ∘ | 66 | 50 | 1.50 | 3.5 |
| Example 8 | | | | | | | | |
| Comparative | None | 0 | 0 | ∘ | 66 | 50 | 1.65 | 3.3 |
| Example 9 | | | | | | | | |
| Comparative | Cl | 50 | 0 | ∘ | 100 | 20 | 1.90 | 1.9 |
| Example 10 | | | | | | | | |

TABLE 2

| | Discoloration after | IR intensity before | IR intensity after | | Opening |
|---|---|---|---|---|---|
| | trickle test | trickle test (X1) | trickle test (X2) | (X2/X1*100 (%) | area (mm²) |
| Example 1 | Small | 0.1739 | 0.1544 | 89 | 4.4 |
| Example 2 | Small | 0.144 | 0.1219 | 85 | 5.2 |
| Example 3 | Small | 0.1409 | 0.1366 | 97 | 3.9 |
| Example 4 | None | 0.0201 | 0.0197 | 98 | 3.5 |
| Example 5 | Small | 0.1182 | 0.1065 | 90 | 6.8 |
| Example 6 | Small | 0.1351 | 0.1037 | 77 | 4.9 |
| Example 7 | Small | 0.1874 | 0.1527 | 82 | 4.8 |
| Example 8 | Small | 0.1819 | 0.1729 | 95 | 4.8 |
| Comparative | Small | 0.1559 | 0.0565 | 36 | 13.8 |
| Example 1 | | | | | |
| Comparative | Seen | 0.1626 | 0.0413 | 25 | 19.7 |
| Example 2 | | | | | |
| Comparative | Seen | 0.1353 | 0.1068 | 79 | 20.2 |
| Example 3 | | | | | |
| Comparative | None | 0.2247 | 0.2024 | 90 | 17.6 |
| Example 4 | | | | | |
| Comparative | Seen | 0.0393 | 0.0087 | 22 | 16.4 |
| Example 5 | | | | | |
| Comparative | Small | 0.1572 | 0.0137 | 9 | 8.4 |
| Example 6 | | | | | |
| Comparative | Seen | 0.1465 | 0.0426 | 29 | 18.2 |
| Example 7 | | | | | |
| Comparative | Small | 0.1379 | 0.1188 | 86 | 9.6 |
| Example 8 | | | | | |
| Comparative | Small | 0.2021 | 0.1882 | 93 | 8.5 |
| Example 9 | | | | | |
| Comparative | Unmeasurable | — | — | — | — |
| Example 10 | | | | | |

In Table 1, “Electron-withdrawing group in aromatic ring of main chain” refers to the type of electron-withdrawing group included in aromatic rings within a main chain; “Withdrawing group content in diamine unit” refers to a ratio of aromatic diamine-derived units having electron-withdrawing groups among the aromatic diamine-derived units in an aramid resin; “Withdrawing group content in acid chloride unit” refers to a ratio of acid chloride-derived units having electron-withdrawing groups among the acid chloride-derived units in an aramid resin; “Presence or absence of terminal amino group” refers to whether or not an amino group is present at a molecular terminal of an aramid resin (a case of presence is represented by the symbol “∘”, and a case of absence is represented by the symbol “x”); “Ratio of aromatic ring connecting amide group” refers to a ratio at which bonds connecting aromatic rings within a main chain have amide groups; “Filler content in porous layer” refers to a content of a filler, where the weight of the porous layer is 100% by weight; “Aramid intrinsic viscosity” refers to an intrinsic viscosity of an aramid resin; and “Weight per unit area” refers to a weight per square meter of a nonaqueous electrolyte secondary battery laminated separator.

In Table 2, “Discoloration after trickle test” refers to a result of taking out the nonaqueous electrolyte secondary battery laminated separator from the test battery after trickle charging and visually observing and comparing a color of the porous layer surface prior to trickle charging and a color of the porous layer surface which was in contact with the positive electrode active material layer after trickle charging; “IR intensity before trickle test”, “IR intensity after trickle test”, and “(X2/X1)*100” refer to X1, X2, and (X2/X1)×100 described in (2. Measurement of IR intensity) above; and “Opening area” is an area of an opening in the nonaqueous electrolyte secondary battery laminated separator described in (1-5. Metal stick piercing test) above.

In the nonaqueous electrolyte secondary battery laminated separators 1 through 8 in accordance with Examples 1 through 8, the area of the opening after the heat resistance test was 7.0 mm² or less, the discoloration was small, and the residual ratio of the amide group was high. Therefore, it can be seen that the nonaqueous electrolyte secondary battery laminated separators 1 through 8 are excellent in heat resistance and in deterioration resistance even when being charged at a high voltage for a long time.

In contrast, in the comparative nonaqueous electrolyte secondary battery laminated separators 1 through 9 in accordance with Comparative Examples 1 through 9, the area of the opening after the heat resistance test greatly exceeded 7.0 mm². Moreover, in the comparative nonaqueous electrolyte secondary battery laminated separator 10 in accordance with Comparative Example 10, a suitable porous layer was not formed. From the results of Examples and Comparative Examples, it is considered that the nonaqueous electrolyte secondary battery laminated separator which is excellent in heat resistance and in deterioration resistance can be obtained by designing an aromatic polyamide having high oxidation resistance and mixing a heat-resistant filler in an appropriate blending amount.

### INDUSTRIAL APPLICABILITY

The nonaqueous electrolyte secondary battery laminated separator in accordance with an embodiment of the present invention can be suitably utilized in various industries which deal with nonaqueous electrolyte secondary batteries.

1. A nonaqueous electrolyte secondary battery laminated separator comprising a polyolefin porous film and a porous layer,
the porous layer containing a binder resin and a filler, and
an area of an opening in said nonaqueous electrolyte secondary battery laminated separator being 7.0 mm² or less when said nonaqueous electrolyte secondary battery laminated separator is subjected to the following heat resistance test:
Step 1) a test battery is prepared by impregnating a laminated body with a nonaqueous electrolyte, the laminated body including a positive electrode, said nonaqueous electrolyte secondary battery laminated separator, and a negative electrode which are stacked in this order such that a positive electrode active material layer included in the positive electrode makes contact with the porous layer, the positive electrode containing a positive electrode active material that is capable of being doped with and dedoped of lithium ions, and the negative electrode containing a negative electrode active material that is capable of being doped with and dedoped of lithium ions;
Step 2) the test battery is subjected to constant-current charging with an electric current of 1 C at 25° C. up to 4.6 V (vs Li/Li⁺), and is then subjected to trickle charging with 4.6 V (vs Li/Li⁺) at 25° C. for 168 hours;
Step 3) said nonaqueous electrolyte secondary battery laminated separator is taken out from the test battery after Step 2;
Step 4) said nonaqueous electrolyte secondary battery laminated separator is pierced with a metal stick having a temperature of 450° C. and a diameter of 2.2 mm from a side on which the porous layer was in contact with the positive electrode active material layer,
wherein the positive electrode is a positive electrode in which lithium nickel cobalt manganese oxide (LiNi_{0.5}Co_{0.2}Mn_{0.3}O₂) is formed on an aluminum foil, the negative electrode is a negative electrode in which natural graphite is formed on a copper foil, and the nonaqueous electrolyte has been prepared by dissolving LiPF₆ in a mixed solvent of ethylene carbonate, ethyl methyl carbonate, and diethyl carbonate at a ratio of 3:5:2 (volume ratio) so that the LiPF₆ is contained at 1 mol/L.

2. The nonaqueous electrolyte secondary battery laminated separator as set forth in claim 1, wherein a content of the filler in the porous layer is not less than 40% by weight and not more than 70% by weight, where a weight of the porous layer is 100% by weight.

3. The nonaqueous electrolyte secondary battery laminated separator as set forth in claim 1, wherein:
the filler is a metal oxide filler; and
the binder resin includes one or more resins selected from the group consisting of a (meth)acrylate-based resin, a fluorine-containing resin, a polyamide-based resin, a polyimide-based resin, a polyamide imide-based resin, a polyester-based resin, and a water-soluble polymer.

4. The nonaqueous electrolyte secondary battery laminated separator as set forth in claim 1, wherein the porous layer contains an aramid resin.

5. The nonaqueous electrolyte secondary battery laminated separator as set forth in claim 4, wherein the aramid resin contained in the porous layer satisfies a relation of (X2/X1)×100≥80(%),
where X1 is (a) maximum peak intensity in a range of 1490 cm⁻¹ to 1530 cm⁻¹ of a surface of the porous layer, the maximum peak intensity being of IR intensity measured in the surface of the porous layer by an ATR-IR method before starting the trickle charging in Step 2; or (b) maximum peak intensity in a range of 1490 cm⁻¹ to 1530 cm⁻¹ of a non-contact part of the surface of the porous layer, the maximum peak intensity being of IR intensity measured in the non-contact part by the ATR-IR method after the trickle charging in Step 2, and the non-contact part having not been in contact with the positive electrode active material layer included in the positive electrode during the trickle charging, and
X2 is maximum peak intensity of a contact part of the surface of the porous layer in a range of 1490 cm⁻¹ to 1530 cm⁻¹, the maximum peak intensity being of IR intensity measured in the contact part by the ATR-IR method after the trickle charging in Step 2, and the contact part having been in contact with the positive electrode active material layer included in the positive electrode during the trickle charging.

6. The nonaqueous electrolyte secondary battery laminated separator as set forth in claim 4, wherein:
in the aramid resin,
(i) each of aromatic rings in a main chain has an electron-withdrawing group,
(ii) at least one end of a molecule is an amino group, and
(iii) more than 90% of bonds with which the aromatic rings in the main chain are connected to each other are amide bonds.

7. The nonaqueous electrolyte secondary battery laminated separator as set forth in claim 6, wherein the aramid resin has no ether bond as the bonds with which the aromatic rings in the main chain are connected to each other.

8. The nonaqueous electrolyte secondary battery laminated separator as set forth in claim 6, wherein:
in the aramid resin,
(iv) 40% or more of aromatic diamine-derived units have electron-withdrawing groups, and
(v) 20% or less of acid chloride-derived units have electron-withdrawing groups.

9. The nonaqueous electrolyte secondary battery laminated separator as set forth in claim 6, wherein the electron-withdrawing group is one or more groups selected from the group consisting of halogen, a cyano group, and a nitro group.

10. The nonaqueous electrolyte secondary battery laminated separator as set forth in claim 4, wherein the aramid resin has an intrinsic viscosity of 1.4 dL/g to 4.0 dL/g.

11. A nonaqueous electrolyte secondary battery member, comprising a positive electrode, a nonaqueous electrolyte secondary battery laminated separator recited in claim 1, and a negative electrode which are stacked in this order.

12. A nonaqueous electrolyte secondary battery, comprising:
a nonaqueous electrolyte secondary battery laminated separator recited in claim 1.

13. A nonaqueous electrolyte secondary battery, comprising:
a nonaqueous electrolyte secondary battery member recited in claim 11.
